(19) United States
(12) Patent Application Publication
(10) Pub. No.: US 2012/0026600 A1
(43) Pub. Date: Feb. 2, 2012

(54) ZOOM LENS SYSTEM, IMAGING DEVICE AND CAMERA

(75) Inventor: Yoshio Matsumura, Osaka (JP)

(73) Assignee: Panasonic Corporation, Osaka (JP)

(21) Appl. No.: 13/192,473

(22) Filed: Jul. 28, 2011

(30) Foreign Application Priority Data
Jul. 28, 2010 (JP) 2010-168897
Jun. 10, 2011 (JP) 2011-130522

(51) Int. Cl. G02B 15/14

(52) U.S. Cl. 359/676

(57) ABSTRACT

A zoom lens system, in order from an object side to an image side, comprising a first lens unit having positive optical power and at least one subsequent lens unit, wherein an interval between the first lens unit and a lens unit which is one of the at least one subsequent lens unit varies in zooming, and at least one lens element among all the lens elements constituting the lens system satisfies the condition: 0.0002399×vd²−0.0123×vd+0.8157−θgF<0 (vd<23) or θgF>0.66 (23≦vd<80), or satisfies the condition: −0.00325×vd+0.69−θgF>0 (ω_{W}>77, vd is an Abbe number to the d-line of the lens element constituting the lens system, θgF is a partial dispersion ratio of the lens element constituting the lens system, ω_{W} is a view angle at a wide-angle limit); an imaging device; and a camera are provided.

### CROSS-REFERENCE TO RELATED APPLICATION

This application is based on application No. 2010-168897 filed in Japan on Jul. 28, 2010 and application No. 2011-130522 filed in Japan on Jun. 10, 2011, the contents of which are hereby incorporated by reference.

### BACKGROUND OF THE INVENTION

1. Field of the Invention

The present invention relates to a zoom lens system, an imaging device, and a camera. In particular, the present invention relates to: a zoom lens system having, as well as a high resolution, a small size and still having a view angle of about 80° at a wide-angle limit, which is satisfactorily adaptable for wide-angle image taking, and further having a very high zoom ratio of 12 or more; an imaging device employing the zoom lens system; and a compact camera employing the imaging device.

2. Description of the Background Art

With recent progress in the development of solid-state image sensors such as a CCD (Charge Coupled Device) and a CMOS (Complementary Metal-Oxide Semiconductor) having a high pixel density, digital still cameras and digital video cameras (simply referred to as “digital cameras”, hereinafter) are rapidly spreading that employ an imaging device including an imaging optical system of high optical performance corresponding to the above-mentioned solid-state image sensors of a high pixel density. Among the digital cameras of high optical performance, in particular, from a convenience point of view, compact digital cameras are strongly requested that employ a zoom lens system having a very high zoom ratio and still being able to cover a wide focal-length range from a wide angle condition to a high telephoto condition in its own right. On the other hand, zoom lens systems are also desired that have a wide angle range where the photographing field is large.

Various kinds of zoom lenses as follows are proposed for the above-mentioned compact digital cameras.

Japanese Laid-Open Patent Publication No. 2005-316047 discloses a zoom lens, in order from the object side to the image side, comprising two lens units of positive and negative, and at least one subsequent lens unit, wherein at least one of the first and second lens units moves in zooming, and a particular relationship is satisfied between the focal length of a lens element having characteristic Abbe number and characteristic partial dispersion ratio and the focal length of a lens unit including the lens element.

Japanese Laid-Open Patent Publication No. 2007-226142 discloses a zoom lens, in order from the object side to the image side, comprising three lens units of positive, negative, and positive, wherein the interval between adjacent lens units varies in zooming, and a lens element having characteristic Abbe number and characteristic partial dispersion ratio is included in the third lens unit.

Japanese Laid-Open Patent Publication No. 2007-298555 discloses a zoom lens, in order from the object side to the image side, comprising two lens units of positive and negative, and a subsequent lens unit, wherein the interval between the first and second lens units varies in zooming, a lens element having characteristic Abbe number and characteristic partial dispersion ratio is included in the first lens unit, and a particular relationship is satisfied between the focal length of the first lens unit and the focal length of the entire system at a telephoto limit.

Japanese Laid-Open Patent Publication No. 2010-026247 discloses a zoom lens comprising a most object side lens unit and a subsequent lens unit, and having an aspheric cemented surface, wherein the amount of deviation of a lens element satisfies a particular condition.

Japanese Laid-Open Patent Publication No. 2010-054667 discloses a zoom lens, in order from the object side to the image side, comprising two lens units of positive and negative, and a subsequent lens unit, wherein the intervals between the respective lens units vary in zooming, the first lens unit includes a cemented lens, and a positive lens, which is one of lens elements constituting the cemented lens, has characteristic Abbe number and characteristic partial dispersion ratio.

However, each of the zoom lenses disclosed in the above-mentioned patent documents has a small view angle at a wide-angle limit, and a low zoom ratio in spite of using many lenses, and therefore does not satisfy the requirements for digital cameras in recent years.

### SUMMARY OF THE INVENTION

An object of the present invention is to provide: a zoom lens system having, as well as a high resolution, a small size and still having a view angle of about 80° at a wide-angle limit, which is satisfactorily adaptable for wide-angle image taking, and further having a very high zoom ratio of 12 or more; an imaging device employing this zoom lens system; and a compact camera employing this imaging device.

(A) The novel concepts disclosed herein were achieved in order to solve the foregoing problems in the conventional art, and herein is disclosed:
a zoom lens system having a plurality of lens units, each lens unit being composed of at least one lens element, the zoom lens system, in order from an object side to an image side, comprising:
a first lens unit having positive optical power; and
at least one subsequent lens unit, wherein
in zooming from a wide-angle limit to a telephoto limit at the time of image taking, an interval between the first lens unit and a lens unit which is one of the at least one subsequent lens unit varies, and
at least one lens element among all the lens elements constituting the lens system satisfies the following condition (1) or (2):

$$\begin{matrix}I ) when vd < 23 \\ 0.0002399 \times {vd}^{2} - 0.0123 \times vd + 0.8157 - θ gF < 0 \\ II ) when 23 \leq vd < 80 \\ θ gF > 0.66\end{matrix} \} \qquad ( 1 )$$

−0.00325×vd+0.69−θgF>0 (2)
(here, ω_{W}>77)
where,
vd is an Abbe number to the d-line of the lens element constituting the lens system,
θgF is a partial dispersion ratio of the lens element constituting the lens system, which is the ratio of a difference between a refractive index to the g-line and a refractive index to the F-line, to a difference between a refractive index to the F-line and a refractive index to the C-line, and
ω_{W} is a view angle (°) at a wide-angle limit.

The novel concepts disclosed herein were achieved in order to solve the foregoing problems in the conventional art, and herein is disclosed:
an imaging device capable of outputting an optical image of an object as an electric image signal, comprising:
a zoom lens system that forms an optical image of the object; and
an image sensor that converts the optical image formed by the zoom lens system into the electric image signal, wherein
the zoom lens system has a plurality of lens units, each lens unit being composed of at least one lens element, and, in order from an object side to an image side, comprises:
a first lens unit having positive optical power; and
at least one subsequent lens unit, wherein
in zooming from a wide-angle limit to a telephoto limit at the time of image taking, an interval between the first lens unit and a lens unit which is one of the at least one subsequent lens unit varies, and
at least one lens element among all the lens elements constituting the lens system satisfies the following condition (1) or (2):

$$\begin{matrix}I ) when vd < 23 \\ 0.0002399 \times {vd}^{2} - 0.0123 \times vd + 0.8157 - θ gF < 0 \\ II ) when 23 \leq vd < 80 \\ θ gF > 0.66\end{matrix} \} \qquad ( 1 )$$

−0.00325×vd+0.69θgF>0 (2)
(here, ω_{W}>77) where,
vd is an Abbe number to the d-line of the lens element constituting the lens system,
θgF is a partial dispersion ratio of the lens element constituting the lens system, which is the ratio of a difference between a refractive index to the g-line and a refractive index to the F-line, to a difference between a refractive index to the F-line and a refractive index to the C-line, and
ω_{W} is a view angle (°) at a wide-angle limit.

The novel concepts disclosed herein were achieved in order to solve the foregoing problems in the conventional art, and herein is disclosed:
a camera for converting an optical image of an object into an electric image signal and then performing at least one of displaying and storing of the converted image signal, comprising:
an imaging device including a zoom lens system that forms an optical image of the object and an image sensor that converts the optical image formed by the zoom lens system into the electric image signal, wherein
the zoom lens system has a plurality of lens units, each lens unit being composed of at least one lens element, and, in order from an object side to an image side, comprises:
a first lens unit having positive optical power; and
at least one subsequent lens unit, wherein
in zooming from a wide-angle limit to a telephoto limit at the time of image taking, an interval between the first lens unit and a lens unit which is one of the at least one subsequent lens unit varies, and
at least one lens element among all the lens elements constituting the lens system satisfies the following condition (1) or (2):

$$\begin{matrix}I ) when vd < 23 \\ 0.0002399 \times {vd}^{2} - 0.0123 \times vd + 0.8157 - θ gF < 0 \\ II ) when 23 \leq vd < 80 \\ θ gF > 0.66\end{matrix} \} \qquad ( 1 )$$

0.00325×vd+0.69−θgF>0 (2)
(here, ω_{W}>77)
where,
vd is an Abbe number to the d-line of the lens element constituting the lens system,
θgF is a partial dispersion ratio of the lens element constituting the lens system, which is the ratio of a difference between a refractive index to the g-line and a refractive index to the F-line, to a difference between a refractive index to the F-line and a refractive index to the C-line, and
ω_{W} is a view angle (°) at a wide-angle limit.
(B) The novel concepts disclosed herein were achieved in order to solve the foregoing problems in the conventional art, and herein is disclosed:
a zoom lens system having a plurality of lens units, each lens unit being composed of at least one lens element, the zoom lens system, in order from an object side to an image side, comprising:
a first lens unit having positive optical power; and
at least one subsequent lens unit, wherein
in zooming from a wide-angle limit to a telephoto limit at the time of image taking, an interval between the first lens unit and a lens unit which is one of the at least one subsequent lens unit varies, and
at least one lens element among all the lens elements constituting the lens system satisfies the following condition (2):

−0.00325×vd+0.69−θgF>0 (2)
(here, f_{T}/f_{W}>12)
where,
vd is an Abbe number to the d-line of the lens element constituting the lens system,
θgF is a partial dispersion ratio of the lens element constituting the lens system, which is the ratio of a difference between a refractive index to the g-line and a refractive index to the F-line, to a difference between a refractive index to the F-line and a refractive index to the C-line,
f_{W} is a focal length of the entire system at a wide-angle limit, and
f_{T} is a focal length of the entire system at a telephoto limit.

The novel concepts disclosed herein were achieved in order to solve the foregoing problems in the conventional art, and herein is disclosed:
an imaging device capable of outputting an optical image of an object as an electric image signal, comprising:
a zoom lens system that forms an optical image of the object; and
an image sensor that converts the optical image formed by the zoom lens system into the electric image signal, wherein
the zoom lens system has a plurality of lens units, each lens unit being composed of at least one lens element, and, in order from an object side to an image side, comprises:
a first lens unit having positive optical power; and
at least one subsequent lens unit, wherein
in zooming from a wide-angle limit to a telephoto limit at the time of image taking, an interval between the first lens unit and a lens unit which is one of the at least one subsequent lens unit varies, and
at least one lens element among all the lens elements constituting the lens system satisfies the following condition (2):

−0.00325×vd+0.69−θgF>0 (2)
(here, f_{T}/f_{W}>12)
where,
vd is an Abbe number to the d-line of the lens element constituting the lens system,
θgF is a partial dispersion ratio of the lens element constituting the lens system, which is the ratio of a difference between a refractive index to the g-line and a refractive index to the F-line, to a difference between a refractive index to the F-line and a refractive index to the C-line,
f_{W} is a focal length of the entire system at a wide-angle limit, and
f_{T} is a focal length of the entire system at a telephoto limit.

The novel concepts disclosed herein were achieved in order to solve the foregoing problems in the conventional art, and herein is disclosed:
a camera for converting an optical image of an object into an electric image signal and then performing at least one of displaying and storing of the converted image signal, comprising:
an imaging device including a zoom lens system that forms an optical image of the object and an image sensor that converts the optical image formed by the zoom lens system into the electric image signal, wherein
the zoom lens system has a plurality of lens units, each lens unit being composed of at least one lens element, and, in order from an object side to an image side, comprises:
a first lens unit having positive optical power; and
at least one subsequent lens unit, wherein
in zooming from a wide-angle limit to a telephoto limit at the time of image taking, an interval between the first lens unit and a lens unit which is one of the at least one subsequent lens unit varies, and
at least one lens element among all the lens elements constituting the lens system satisfies the following condition (2):

−0.00325×vd+0.69−θgF>0 (2)
(here, f_{T}/f_{W}>12)
where,
vd is an Abbe number to the d-line of the lens element constituting the lens system,
θgF is a partial dispersion ratio of the lens element constituting the lens system, which is the ratio of a difference between a refractive index to the g-line and a refractive index to the F-line, to a difference between a refractive index to the F-line and a refractive index to the C-line,
f_{W} is a focal length of the entire system at a wide-angle limit, and
f_{T} is a focal length of the entire system at a telephoto limit.

According to the present invention, a zoom lens system can be provided that has, as well as a high resolution, a small size and still has a view angle of about 80° at a wide-angle limit, which is satisfactorily adaptable for wide-angle image taking, and that has a very high zoom ratio of about 12 to 40. Further, according to the present invention, an imaging device employing the zoom lens system and a thin and very compact camera employing the imaging device can be provided.

### BRIEF DESCRIPTION OF THE DRAWINGS

This and other objects and features of this invention will become clear from the following description, taken in conjunction with the preferred embodiments with reference to the accompanied drawings in which:

FIG. 1 is a lens arrangement diagram showing an infinity in-focus condition of a zoom lens system according to Embodiment 1 (Example 1);

FIG. 2 is a longitudinal aberration diagram of an infinity in-focus condition of a zoom lens system according to Example 1;

FIG. 3 is a lateral aberration diagram of a zoom lens system according to Example 1 at a telephoto limit in a basic state where image blur compensation is not performed and in a blur compensation state;

FIG. 4 is a lens arrangement diagram showing an infinity in-focus condition of a zoom lens system according to Embodiment 2 (Example 2);

FIG. 5 is a longitudinal aberration diagram of an infinity in-focus condition of a zoom lens system according to Example 2;

FIG. 6 is a lateral aberration diagram of a zoom lens system according to Example 2 at a telephoto limit in a basic state where image blur compensation is not performed and in a blur compensation state;

FIG. 7 is a lens arrangement diagram showing an infinity in-focus condition of a zoom lens system according to Embodiment 3 (Example 3);

FIG. 8 is a longitudinal aberration diagram of an infinity in-focus condition of a zoom lens system according to Example 3;

FIG. 9 is a lateral aberration diagram of a zoom lens system according to Example 3 at a telephoto limit in a basic state where image blur compensation is not performed and in a blur compensation state;

FIG. 10 is a lens arrangement diagram showing an infinity in-focus condition of a zoom lens system according to Embodiment 4 (Example 4);

FIG. 11 is a longitudinal aberration diagram of an infinity in-focus condition of a zoom lens system according to Example 4;

FIG. 12 is a lateral aberration diagram of a zoom lens system according to Example 4 at a telephoto limit in a basic state where image blur compensation is not performed and in a blur compensation state;

FIG. 13 is a lens arrangement diagram showing an infinity in-focus condition of a zoom lens system according to Embodiment 5 (Example 5);

FIG. 14 is a longitudinal aberration diagram of an infinity in-focus condition of a zoom lens system according to Example 5;

FIG. 15 is a lateral aberration diagram of a zoom lens system according to Example 5 at a telephoto limit in a basic state where image blur compensation is not performed and in a blur compensation state; and

FIG. 16 is a schematic construction diagram of a digital still camera according to Embodiment 6.

### DESCRIPTION OF THE PREFERRED EMBODIMENTS

### Embodiments 1 to 5

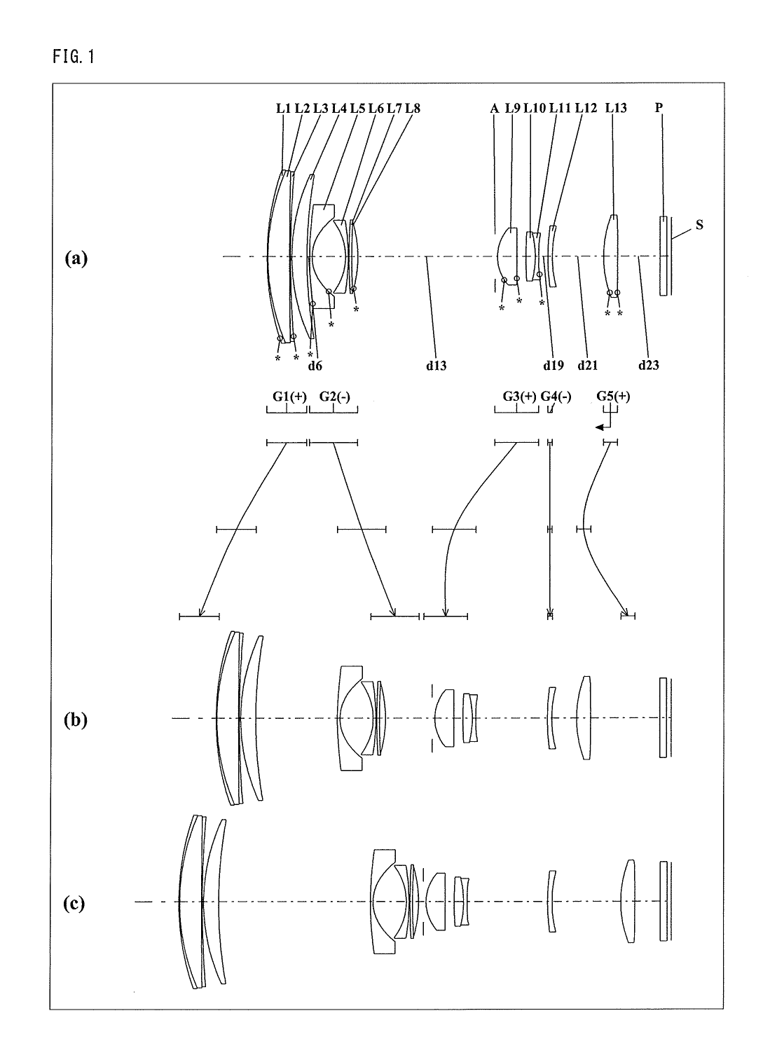

FIGS. 1, 4, 7, 10, and 13 are lens arrangement diagrams of zoom lens systems according to Embodiments 1 to 5, respectively.

Each of FIGS. 1, 4, 7, 10, and 13 shows a zoom lens system in an infinity in-focus condition. In each Fig., part (a) shows a lens configuration at a wide-angle limit (in the minimum focal length condition: focal length f_{W}), part (b) shows a lens configuration at a middle position (in an intermediate focal length condition: focal length f_{M}=√(f_{W}*f_{T})), and part (c) shows a lens configuration at a telephoto limit (in the maximum focal length condition: focal length f_{T}). Further, in each Fig., an arrow of straight or curved line provided between part (a) and part (b) indicates the movement of each lens unit from a wide-angle limit through a middle position to a telephoto limit. Moreover, in each Fig., an arrow imparted to a lens unit indicates focusing from an infinity in-focus condition to a close-object in-focus condition. That is, the arrow indicates the moving direction at the time of focusing from an infinity in-focus condition to a close-object in-focus condition.

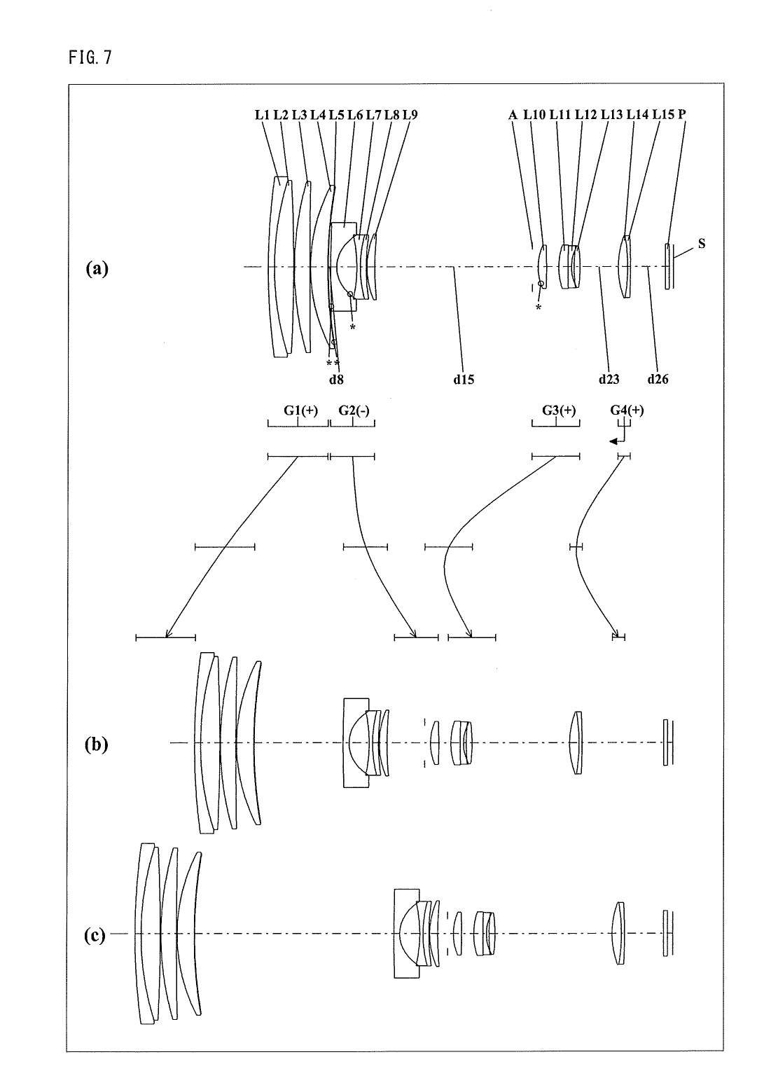

Further, in FIGS. 1, 4, 7, 10, and 13, an asterisk “*” imparted to a particular surface indicates that the surface is aspheric. In each Fig., symbol (+) or (−) imparted to the symbol of each lens unit corresponds to the sign of the optical power of the lens unit. In each Fig., the straight line located on the most right-hand side indicates the position of the image surface S. On the object side relative to the image surface S (that is, between the image surface S and the most image side lens surface of the fifth lens unit G5 in FIGS. 1, 4, 10, and 13; and between the image surface S and the most image side lens surface of the fourth lens unit G4 in FIG. 7), a plane parallel plate P equivalent to an optical low-pass filter or a face plate of an image sensor is provided.

Further, in FIGS. 1, 4, 7, 10, and 13, an aperture diaphragm A is provided closest to the object side in the third lens unit G3, i.e., between the second lens unit G2 and the third lens unit G3.

As shown in FIG. 1, in the zoom lens system according to Embodiment 1, the first lens unit G1, in order from the object side to the image side, comprises: a negative meniscus first lens element L1 with the convex surface facing the object side; a positive meniscus second lens element L2 with the convex surface facing the object side; a negative meniscus third lens element L3 with the convex surface facing the object side; and a positive meniscus fourth lens element L4 with the convex surface facing the object side. Among these, the first lens element L1, the second lens element L2, and the third lens element L3 are cemented with each other. The first lens element L1 has an aspheric object side surface, and the third lens element L3 has an aspheric image side surface. The first lens element L1 and the third lens element L3 are lens elements made of a fine particle dispersed material.

In the zoom lens system according to Embodiment 1, the second lens unit G2, in order from the object side to the image side, comprises: a negative meniscus fifth lens element L5 with the convex surface facing the object side; a negative meniscus sixth lens element L6 with the convex surface facing the image side; a negative meniscus seventh lens element L7 with the convex surface facing the object side; and a bi-convex eighth lens element L8. Among these, the seventh lens element L7 and the eighth lens element L8 are cemented with each other. The fifth lens element L5 has two aspheric surfaces, and the eighth lens element L8 has an aspheric image side surface. The eighth lens element L8 is a lens element made of a fine particle dispersed material.

In the zoom lens system according to Embodiment 1, the third lens unit G3, in order from the object side to the image side, comprises: a positive meniscus ninth lens element L9 with the convex surface facing the object side; a bi-convex tenth lens element L10; and a bi-concave eleventh lens element L11. Among these, the tenth lens element L10 and the eleventh lens element L11 are cemented with each other. The ninth lens element L9 has two aspheric surfaces, and the eleventh lens element L11 has an aspheric image side surface.

In the zoom lens system according to Embodiment 1, the fourth lens unit G4 comprises solely a negative meniscus twelfth lens element L12 with the convex surface facing the object side.

In the zoom lens system according to Embodiment 1, the fifth lens unit G5 comprises solely a bi-convex thirteenth lens element L13. The thirteenth lens element L13 has two aspheric surfaces.

In the zoom lens system according to Embodiment 1, a plane parallel plate P is provided on the object side relative to the image surface S (between the image surface S and the thirteenth lens element L13).

In the zoom lens system according to Embodiment 1, in zooming from a wide-angle limit to a telephoto limit at the time of image taking, the first lens unit G1 moves to the object side, the second lens unit G2 moves to the image side, the third lens unit G3 moves to the object side together with the aperture diaphragm A, the fourth lens unit G4 does not move, and the fifth lens unit G5 moves to the image side with locus of a convex to the object side.

That is, in zooming, the first lens unit G1, the second lens unit G2, the third lens unit G3, and the fifth lens unit G5 individually move along the optical axis such that the interval between the first lens unit G1 and the second lens unit G2 should increase, that the interval between the second lens unit G2 and the third lens unit G3 should decrease, and that the interval between the third lens unit G3 and the fourth lens unit G4 should increase.

On the other hand, in focusing from an infinity in-focus condition to a close-object in-focus condition, the fifth lens unit G5 moves to the object side along the optical axis.

Further, by moving the third lens unit G3 in a direction perpendicular to the optical axis, image point movement caused by vibration of the entire system can be compensated, that is, image blur caused by hand blurring, vibration and the like can be compensated optically.

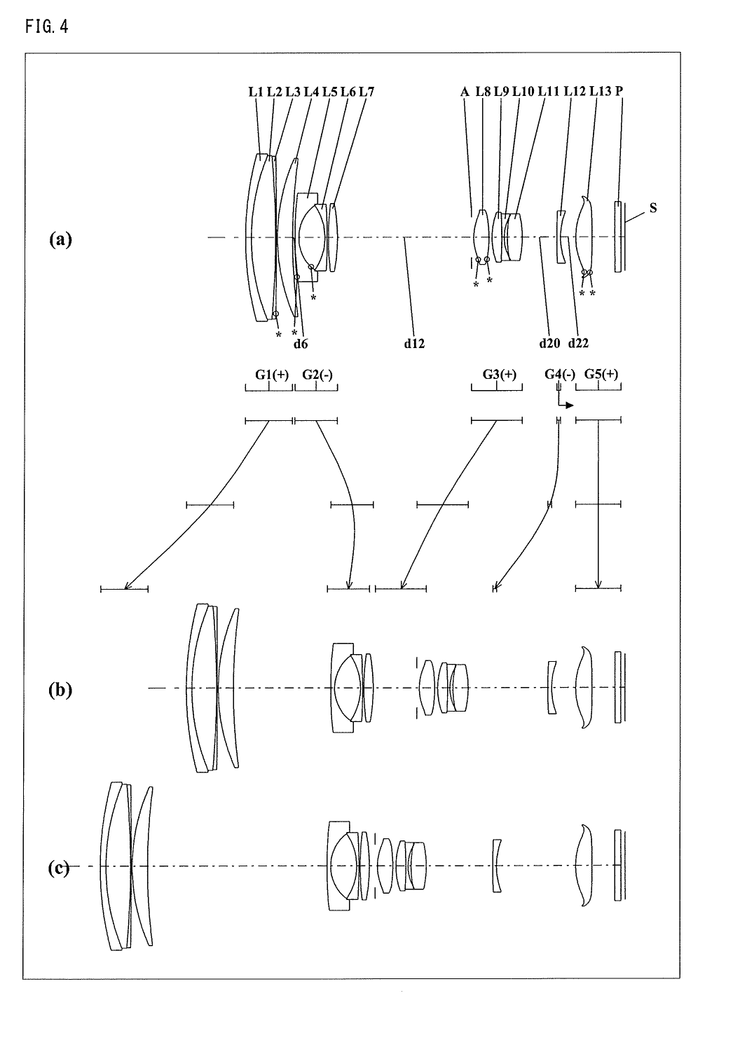

As shown in FIG. 4, in the zoom lens system according to Embodiment 2, the first lens unit G1, in order from the object side to the image side, comprises: a negative meniscus first lens element L1 with the convex surface facing the object side; a bi-convex second lens element L2; a negative meniscus third lens element L3 with the convex surface facing the image side; and a positive meniscus fourth lens element L4 with the convex surface facing the object side. Among these, the first lens element L1, the second lens element L2, and the third lens element L3 are cemented with each other. The third lens element L3 has an aspheric image side surface. The third lens element L3 is a lens element made of a fine particle dispersed material.

In the zoom lens system according to Embodiment 2, the second lens unit G2, in order from the object side to the image side, comprises: a negative meniscus fifth lens element L5 with the convex surface facing the object side; a negative meniscus sixth lens element L6 with the convex surface facing the image side; and a bi-convex seventh lens element L7. The fifth lens element L5 has two aspheric surfaces.

In the zoom lens system according to Embodiment 2, the third lens unit G3, in order from the object side to the image side, comprises: a bi-convex eighth lens element L8; a bi-convex ninth lens element L9, a bi-concave tenth lens element L10, and a bi-convex eleventh lens element L11. Among these, the ninth lens element L9 and the tenth lens element L10 are cemented with each other. The eighth lens element L8 has two aspheric surfaces. The eleventh lens element L11 is a lens element made of a fine particle dispersed material.

In the zoom lens system according to Embodiment 2, the fourth lens unit G4 comprises solely a negative meniscus twelfth lens element L12 with the convex surface facing the object side.

In the zoom lens system according to Embodiment 2, the fifth lens unit G5 comprises solely a bi-convex thirteenth lens element L13. The thirteenth lens element L13 has two aspheric surfaces.

In the zoom lens system according to Embodiment 2, a plane parallel plate P is provided on the object side relative to the image surface S (between the image surface S and the thirteenth lens element L13).

In the zoom lens system according to Embodiment 2, in zooming from a wide-angle limit to a telephoto limit at the time of image taking, the first lens unit G1 moves to the object side, the second lens unit G2 moves to the image side with locus of a convex to the image side, the third lens unit G3 moves to the object side together with the aperture diaphragm A, the fourth lens unit G4 moves to the object side, and the fifth lens unit G5 does not move.

That is, in zooming, the first lens unit G1, the second lens unit G2, the third lens unit G3, and the fourth lens unit G4 individually move along the optical axis such that the interval between the first lens unit G1 and the second lens unit G2 should increase, that the interval between the second lens unit G2 and the third lens unit G3 should decrease, and that the interval between the fourth lens unit G4 and the fifth lens unit G5 should increase.

On the other hand, in focusing from an infinity in-focus condition to a close-object in-focus condition, the fourth lens unit G4 moves to the image side along the optical axis.

Further, by moving the third lens unit G3 in a direction perpendicular to the optical axis, image point movement caused by vibration of the entire system can be compensated, that is, image blur caused by hand blurring, vibration and the like can be compensated optically.

As shown in FIG. 7, in the zoom lens system according to Embodiment 3, the first lens unit G1, in order from the object side to the image side, comprises: a negative meniscus first lens element L1 with the convex surface facing the object side; a bi-convex second lens element L2; a positive meniscus third lens element L3 with the convex surface facing the object side; a positive meniscus fourth lens element L4 with the convex surface facing the object side; and a negative meniscus fifth lens element L5 with the convex surface facing the object side. Among these, the first lens element L1 and the second lens element L2 are cemented with each other, and the fourth lens element L4 and the fifth lens element L5 are cemented with each other. The fifth lens element L5 has an aspheric image side surface. Further, the fifth lens element L5 is a lens element made of a fine particle dispersed material.

In the zoom lens system according to Embodiment 3, the second lens unit G2, in order from the object side to the image side, comprises: a negative meniscus sixth lens element L6 with the convex surface facing the object side; a bi-concave seventh lens element L7; a positive meniscus eighth lens element L8 with the convex surface facing the object side; and a positive meniscus ninth lens element L9 with the convex surface facing the object side. Among these, the seventh lens element L7 and the eighth lens element L8 are cemented with each other. The sixth lens element L6 has two aspheric surfaces. Further, the eighth lens element L8 is a lens element made of a fine particle dispersed material.

In the zoom lens system according to Embodiment 3, the third lens unit G3, in order from the object side to the image side, comprises: a bi-convex tenth lens element L10; a positive meniscus eleventh lens element L11 with the convex surface facing the object side; a negative meniscus twelfth lens element L12 with the convex surface facing the object side; and a bi-convex thirteenth lens element L13. Among these, the eleventh lens element L11 and the twelfth lens element L12 are cemented with each other. The tenth lens element L10 has an aspheric object side surface.

In the zoom lens system according to Embodiment 3, the fourth lens unit G4, in order from the object side to the image side, comprises: a bi-convex fourteenth lens element L14; and a negative meniscus fifteenth lens element L15 with the convex surface facing the image side. The fourteenth lens element L14 and the fifteenth lens element L15 are cemented with each other.

In the zoom lens system according to Embodiment 3, a plane parallel plate P is provided on the object side relative to the image surface S (between the image surface S and the fifteenth lens element L15).

In the zoom lens system according to Embodiment 3, in zooming from a wide-angle limit to a telephoto limit at the time of image taking, the first lens unit G1 moves to the object side, the second lens unit G2 moves to the image side, the third lens unit G3 moves, together with the aperture diaphragm A, to the object side with locus of a convex to the object side, and the fourth lens unit G4 moves to the object side with locus of a convex to the object side.

That is, in zooming, the individual lens units move along the optical axis such that the interval between the first lens unit G1 and the second lens unit G2 should increase, and that the interval between the second lens unit G2 and the third lens unit G3 should decrease.

On the other hand, in focusing from an infinity in-focus condition to a close-object in-focus condition, the fourth lens unit G4 moves to the object side along the optical axis.

Further, by moving the third lens unit G3 in a direction perpendicular to the optical axis, image point movement caused by vibration of the entire system can be compensated, that is, image blur caused by hand blurring, vibration and the like can be compensated optically.

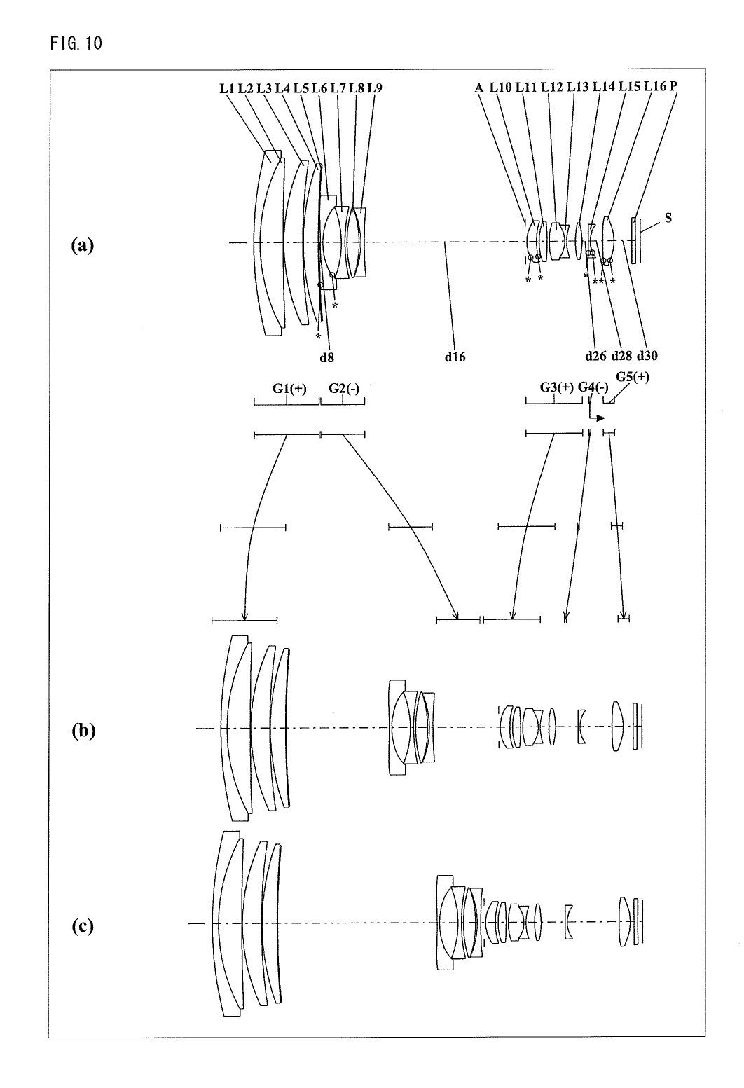

As shown in FIG. 10, in the zoom lens system according to Embodiment 4, the first lens unit G1, in order from the object side to the image side, comprises: a negative meniscus first lens element L1 with the convex surface facing the object side; a positive meniscus second lens element L2 with the convex surface facing the object side; a positive meniscus third lens element L3 with the convex surface facing the object side; a positive meniscus fourth lens element L4 with the convex surface facing the object side; and a negative meniscus fifth lens element L5 with the convex surface facing the object side. Among these, the first lens element L1 and the second lens element L2 are cemented with each other, and the fourth lens element L4 and the fifth lens element L5 are cemented with each other. The fifth lens element L5 is a lens element made of a fine particle dispersed material.

In the zoom lens system according to Embodiment 4, the second lens unit G2, in order from the object side to the image side, comprises: a bi-concave sixth lens element L6; a bi-concave seventh lens element L7; a bi-convex eighth lens element L8; and a bi-concave ninth lens element L9. The sixth lens element L6 has two aspheric surfaces.

In the zoom lens system according to Embodiment 4, the third lens unit G3, in order from the object side to the image side, comprises: a positive meniscus tenth lens element L10 with the convex surface facing the object side; a bi-convex eleventh lens element L11; a bi-convex twelfth lens element L12; a bi-concave thirteenth lens element L13; and a bi-convex fourteenth lens element L14. Among these, the twelfth lens element L12 and the thirteenth lens element L13 are cemented with each other. The tenth lens element L10 has two aspheric surfaces.

In the zoom lens system according to Embodiment 4, the fourth lens unit G4 comprises solely a bi-concave fifteenth lens element L15. The fifteenth lens element L15 has two aspheric surfaces.

In the zoom lens system according to Embodiment 4, the fifth lens unit G5 comprises solely a bi-convex sixteenth lens element L16. The sixteenth lens element L16 has two aspheric surfaces. The sixteenth lens element L16 is a lens element made of a fine particle dispersed material.

In the zoom lens system according to Embodiment 4, a plane parallel plate P is provided on the object side relative to the image surface S (between the image surface S and the sixteenth lens element L16).

In the zoom lens system according to Embodiment 4, in zooming from a wide-angle limit to a telephoto limit at the time of image taking, the first lens unit G1 moves to the object side, the second lens unit G2 moves to the image side, the third lens unit G3 moves to the object side together with the aperture diaphragm A, the fourth lens unit G4 moves to the object side, and the fifth lens unit G5 moves to the image side.

That is, in zooming, the individual lens units move along the optical axis such that the interval between the first lens unit G1 and the second lens unit G2 should increase, that the interval between the second lens unit G2 and the third lens unit G3 should decrease, and that the interval between the fourth lens unit G4 and the fifth lens unit G5 should increase.

On the other hand, in focusing from an infinity in-focus condition to a close-object in-focus condition, the fourth lens unit G4 moves to the image side along the optical axis.

Further, by moving the third lens unit G3 in a direction perpendicular to the optical axis, image point movement caused by vibration of the entire system can be compensated, that is, image blur caused by hand blurring, vibration and the like can be compensated optically.

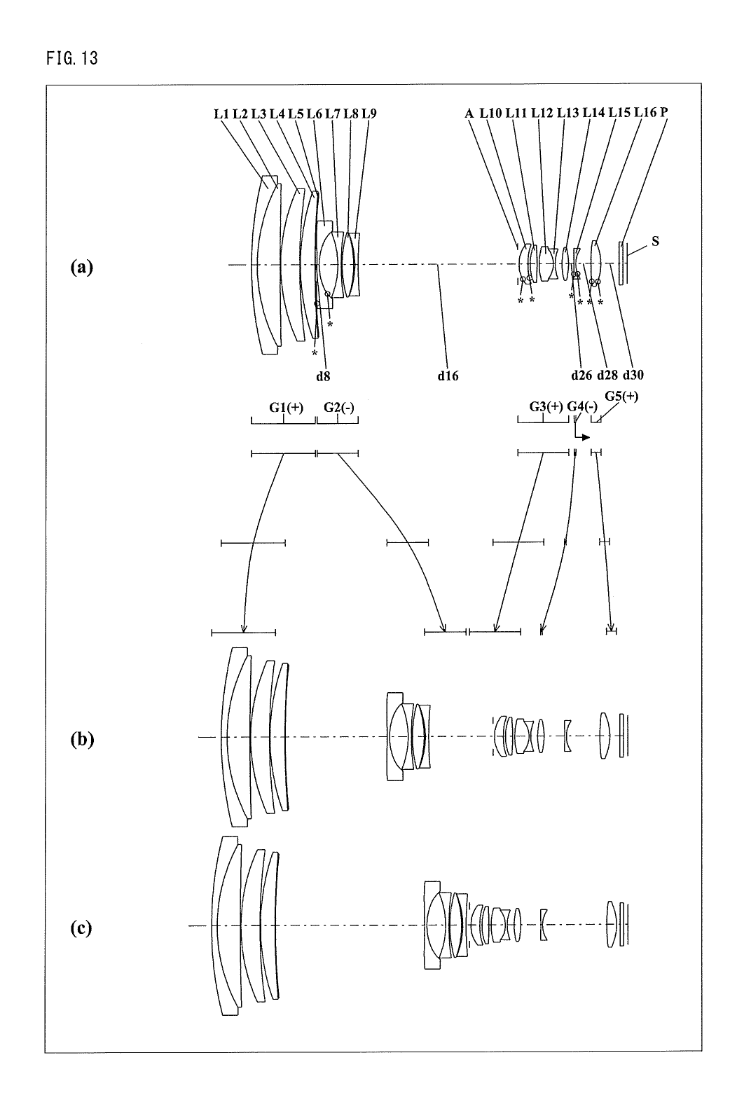

As shown in FIG. 13, in the zoom lens system according to Embodiment 5, the first lens unit G1, in order from the object side to the image side, comprises: a negative meniscus first lens element L1 with the convex surface facing the object side; a positive meniscus second lens element L2 with the convex surface facing the object side; a positive meniscus third lens element L3 with the convex surface facing the object side; a positive meniscus fourth lens element L4 with the convex surface facing the object side; and a negative meniscus fifth lens element L5 with the convex surface facing the object side. Among these, the first lens element L1 and the second lens element L2 are cemented with each other, and the fourth lens element L4 and the fifth lens element L5 are cemented with each other. The fifth lens element L5 is a lens element made of a fine particle dispersed material.

In the zoom lens system according to Embodiment 5, the second lens unit G2, in order from the object side to the image side, comprises: a bi-concave sixth lens element L6; a bi-concave seventh lens element L7; a bi-convex eighth lens element L8; and a bi-concave ninth lens element L9. The sixth lens element L6 has two aspheric surfaces.

In the zoom lens system according to Embodiment 5, the third lens unit G3, in order from the object side to the image side, comprises: a positive meniscus tenth lens element L10 with the convex surface facing the object side; a bi-convex eleventh lens element L11; a bi-convex twelfth lens element L12; a bi-concave thirteenth lens element L13; and a bi-convex fourteenth lens element L14. Among these, the twelfth lens element L12 and the thirteenth lens element L13 are cemented with each other. The tenth lens element L10 has two aspheric surfaces.

In the zoom lens system according to Embodiment 5, the fourth lens unit G4 comprises solely a bi-concave fifteenth lens element L15. The fifteenth lens element L15 has two aspheric surfaces.

In the zoom lens system according to Embodiment 5, the fifth lens unit G5 comprises solely a bi-convex sixteenth lens element L16. The sixteenth lens element L16 has two aspheric surfaces. The sixteenth lens element L16 is a lens element made of a fine particle dispersed material.

In the zoom lens system according to Embodiment 5, a plane parallel plate P is provided on the object side relative to the image surface S (between the image surface S and the sixteenth lens element L16).

In the zoom lens system according to Embodiment 5, in zooming from a wide-angle limit to a telephoto limit at the time of image taking, the first lens unit G1 moves to the object side, the second lens unit G2 moves to the image side, the third lens unit G3 moves to the object side together with the aperture diaphragm A, the fourth lens unit G4 moves to the object side, and the fifth lens unit G5 moves to the image side.

That is, in zooming, the individual lens units move along the optical axis such that the interval between the first lens unit G1 and the second lens unit G2 should increase, that the interval between the second lens unit G2 and the third lens unit G3 should decrease, and that the interval between the fourth lens unit G4 and the fifth lens unit G5 should increase.

On the other hand, in focusing from an infinity in-focus condition to a close-object in-focus condition, the fourth lens unit G4 moves to the image side along the optical axis.

Further, by moving the third lens unit G3 in a direction perpendicular to the optical axis, image point movement caused by vibration of the entire system can be compensated, that is, image blur caused by hand blurring, vibration and the like can be compensated optically.

In the present invention, a fine particle dispersed material, which is a material of some lens elements, is obtained by dispersing inorganic particles in a resin as described later. There is no particular limit to the kinds of resin and inorganic particles, and any resin and inorganic particles may be adopted so long as they are available for lens elements. Further, there is no particular limit to the combination of resin and inorganic particles, and any combination of resin and inorganic particles may be adopted so long as a lens element having desired refractive index, Abbe number, partial dispersion ratio and the like can be obtained.

The following description is given for conditions preferred to be satisfied by a zoom lens system like the zoom lens systems according to Embodiments 1 to 5. Here, a plurality of preferable conditions are set forth for the zoom lens system according to each embodiment. A construction that satisfies all the plural conditions is most desirable for the zoom lens system. However, when an individual condition is satisfied, a zoom lens system having the corresponding effect is obtained.

For example, in a zoom lens system like the zoom lens systems according to Embodiments 1 to 5, which comprises, in order from an object side to an image side, a first lens unit having positive optical power, and at least one subsequent lens unit, wherein an interval between the first lens unit and a lens unit which is one of the at least one subsequent lens unit varies in zooming from a wide-angle limit to a telephoto limit at the time of image taking (this lens configuration is referred to as basic configuration of the embodiment, hereinafter), at least one lens element among all the lens elements constituting the lens system satisfies the following condition (1) or (2).

$$\begin{matrix}I ) when vd < 23 \\ 0.0002399 \times {vd}^{2} - 0.0123 \times vd + 0.8157 - θ gF < 0 \\ II ) when 23 \leq vd < 80 \\ θ gF > 0.66\end{matrix} \} \qquad ( 1 )$$

−0.00325×vd+0.69−θgF>0 (2)
(here, ω_{W}>77)
where,
vd is an Abbe number to the d-line of the lens element constituting the lens system,
θgF is a partial dispersion ratio of the lens element constituting the lens system, which is the ratio of a difference between a refractive index to the g-line and a refractive index to the F-line, to a difference between a refractive index to the F-line and a refractive index to the C-line, and
ω_{W} is a view angle (°) at a wide-angle limit.

In a zoom lens system having the basic configuration like the zoom lens systems according to Embodiments 1 to 5, at least one lens element among all the lens elements constituting the lens system satisfies the following condition (2).

−0.00325×vd+0.69−θgF>0 (2)
(here, f_{T}/f_{W}>12)
where,
vd is an Abbe number to the d-line of the lens element constituting the lens system,
θgF is a partial dispersion ratio of the lens element constituting the lens system, which is the ratio of a difference between a refractive index to the g-line and a refractive index to the F-line, to a difference between a refractive index to the F-line and a refractive index to the C-line,
f_{W} is a focal length of the entire system at a wide-angle limit, and
f_{T} is a focal length of the entire system at a telephoto limit.

The conditions (1) and (2) set forth the partial dispersion ratio of the lens element. When the condition (1) or (2) is not satisfied, control of a secondary spectrum becomes difficult. In this case, in order to successfully compensate chromatic aberration, the overall length of the zoom lens system should be increased, or the number of lens elements should be increased. That is, it becomes difficult to provide compact lens barrel, imaging device, and camera.

When the following condition (1)′ or (2)′ is satisfied, the above-mentioned effect is achieved more successfully.

$$\begin{matrix}I ) when vd < 23 \\ 0.0002399 \times {vd}^{2} - 0.0123 \times vd + 0.9157 - θ gF < 0 \\ II ) when 23 \leq vd < 80 \\ θ gF > 0.76\end{matrix} \} \qquad {( 1 )}^{′}$$

−0.00325×vd+0.59−θgF>0 (2)′

Because occurrence of the secondary spectrum can be suppressed and chromatic aberration can be successfully compensated, it is desirable that at least one of the lens elements constituting the first lens unit among all the lens elements constituting the lens system satisfies the above-mentioned condition (1) or (2).

In a zoom lens system having the basic configuration like the zoom lens systems according to Embodiments 1 to 5, it is preferable that the following condition (3) is satisfied.

0.20<(L_{T}×f_{W})/(H_{T}×f_{T})<1.31 (3)
where,
L_{T} is an overall length of lens system at a telephoto limit (an optical axial distance from an object side surface of a lens element positioned closest to the object side in the lens system, to an image surface),
f_{W} is a focal length of the entire system at a wide-angle limit,
f_{T} is a focal length of the entire system at a telephoto limit, and
H_{T} is an image height at a telephoto limit.

The condition (3) sets forth the overall length of lens system at a telephoto limit and the zoom ratio. When the value exceeds the upper limit of the condition (3), the overall length of lens system at a telephoto limit is increased relative to the zoom ratio, and thus the effective diameter of the first lens unit is increased. That is, it becomes difficult to provide compact lens barrel, imaging device, and camera. On the other hand, when the value goes below the lower limit of the condition (3), the overall length of lens system at a telephoto limit is decreased relative to the zoom ratio, which makes it difficult to compensate axial chromatic aberration at a telephoto limit.

When at least one of the following conditions (3)′ and (3)″ is satisfied, the above-mentioned effect is achieved more successfully.

0.50<(L_{T}×f_{W})/(H_{T}×f_{T}) (3)′

(L_{T}×f_{W})/(H_{T}×f_{T})<0.99 (3)″

In a zoom lens system having the basic configuration like the zoom lens systems according to Embodiments 1 to 5, it is preferable that the following condition (4) is satisfied.

0.10<(f₁×f_{W})/(H_{T}×f_{T})<0.73 (4)
where,
f₁ is a focal length of the first lens unit,
f_{W} is a focal length of the entire system at a wide-angle limit,
f_{T} is a focal length of the entire system at a telephoto limit, and
H_{T} is an image height at a telephoto limit.

The condition (4) sets forth the focal length of the first lens unit and the zoom ratio. When the value exceeds the upper limit of the condition (4), the focal length of the first lens unit is increased, and thus the effective diameter of the first lens unit is increased. That is, it becomes difficult to provide compact lens barrel, imaging device, and camera. In addition, it becomes difficult to control distortion at a wide-angle limit. On the other hand, when the value goes below the lower limit of the condition (4), the focal length of the first lens unit is decreased, which makes it difficult to control curvature of field at a wide-angle limit.

When at least one of the following conditions (4)′ and (4)″ is satisfied, the above-mentioned effect is achieved more successfully.

0.20<(f₁×f_{W})/(H_{T}×f_{T}) (4)″

(f₁×f_{W})/(H_{T}×f_{T})<0.54 (4)″

In a zoom lens system which has the basic configuration like the zoom lens systems according to Embodiments 1 to 5 and includes a second lens unit located closest to the object side in the subsequent lens units, it is preferable that the following condition (5) is satisfied.

−80.00<f_{T}/f₂<−12.31 (5)
where,
f_{T} is a focal length of the entire system at a telephoto limit, and
f₂ is a focal length of the second lens unit.

The condition (5) sets forth the focal length of the entire system at a telephoto limit and the focal length of the second lens unit. When the value exceeds the upper limit of the condition (5), the focal length of the second lens unit is increased, and thus the effective diameter of the second lens unit is increased, which makes it difficult to control distortion at a wide-angle limit. On the other hand, when the value goes below the lower limit of the condition (5), the focal length of the second lens unit is decreased, which makes it difficult to compensate astigmatism in the entire zooming region.

When at least one of the following conditions (5)′ and (5)″ is satisfied, the above-mentioned effect is achieved more successfully.

−40.00<f_{T}/f₂ (5)″

f_{T}/f₂<−13.45 (5)″

In a zoom lens system which has the basic configuration like the zoom lens systems according to Embodiments 1 to 5 and includes a second lens unit located closest to the object side in the subsequent lens units, it is preferable that the following condition (6) is satisfied.

11.76<f_{T}/M₂<70.00 (6)
where,
f_{T} is a focal length of the entire system at a telephoto limit, and
M₂ is an optical axial thickness of the second lens unit (an optical axial distance from an object side surface of a most object side lens element to an image side surface of a most image side lens element).

The condition (6) sets forth the focal length of the entire system at a telephoto limit and the optical axial thickness of the second lens unit. When the value exceeds the upper limit of the condition (6), the optical axial thickness of the second lens unit is decreased, and thus the number of lens elements constituting the second lens unit is decreased, which makes it difficult to compensate astigmatism in the entire zooming region, particularly. In addition, the thickness of each of the lens elements constituting the second lens unit is decreased, which makes it difficult to manufacture the lens elements. On the other hand, when the value goes below the lower limit of the condition (6), the optical axial thickness of the second lens unit is increased, and thus the effective diameter of the first lens unit is increased. That is, it becomes difficult to provide compact lens barrel, imaging device, and camera. In addition, the height of light beam in the first lens unit and the second lens unit is increased, which makes it difficult to control curvature of field at a wide-angle limit.

When at least one of the following conditions (6)′ and (6)″ is satisfied, the above-mentioned effect is achieved more successfully.

12.13<f_{T}/M₂ (6)′

f_{T}/M₂<30.00 (6)″

In a zoom lens system which has the basic configuration like the zoom lens systems according to Embodiments 1 to 5 and in which the first lens unit includes a lens element satisfying the condition (2), it is preferable that the lens element satisfying the condition (2) satisfies the following condition (7).

1/R₁−1/R₂<0 (7)
where,
R₁ is a radius of curvature of an object side surface of the lens element satisfying the condition (2), and
R₂ is a radius of curvature of an image side surface of the lens element satisfying the condition (2).

The condition (7) sets forth the shape of the lens element satisfying the condition (2). When the condition (7) is not satisfied, it becomes difficult to control the secondary spectrum at a telephoto limit.

When the following condition (7)′ is satisfied, the above-mentioned effect is achieved more successfully.

1/R₁−1/R₂<−0.002 (7)′

Each of the lens units constituting the zoom lens system according to any of Embodiments 1 to 5 is composed exclusively of refractive type lens elements that deflect the incident light by refraction (that is, lens elements of a type in which deflection is achieved at the interface between media each having a distinct refractive index). However, the present invention is not limited to this. For example, the lens units may employ diffractive type lens elements that deflect the incident light by diffraction; refractive-diffractive hybrid type lens elements that deflect the incident light by a combination of diffraction and refraction; or gradient index type lens elements that deflect the incident light by distribution of refractive index in the medium. In particular, in refractive-diffractive hybrid type lens elements, when a diffraction structure is formed in the interface between media having mutually different refractive indices, wavelength dependence in the diffraction efficiency is improved. Thus, such a configuration is preferable.

### Embodiment 6

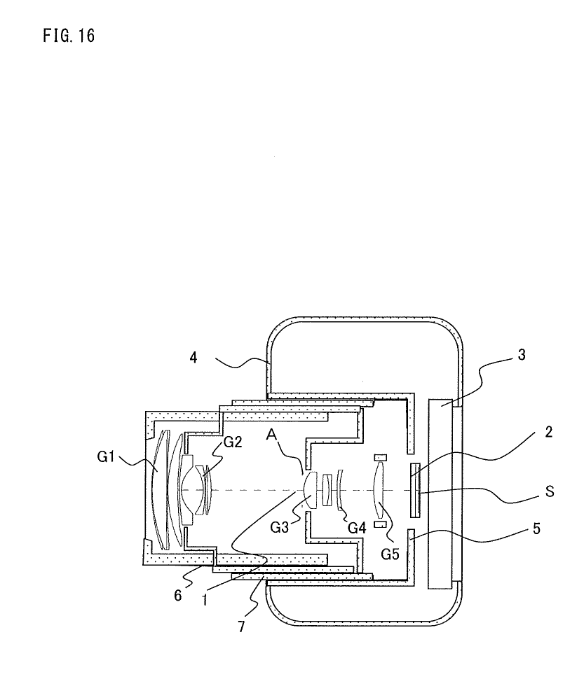

FIG. 16 is a schematic construction diagram of a digital still camera according to Embodiment 6. In FIG. 16, the digital still camera comprises: an imaging device having a zoom lens system 1 and an image sensor 2 composed of a CCD; a liquid crystal display monitor 3; and a body 4. The employed zoom lens system 1 is a zoom lens system according to Embodiment 1. In FIG. 16, the zoom lens system 1, in order from the object side to the image side, comprises a first lens unit G1, a second lens unit G2, an aperture diaphragm A, a third lens unit G3, a fourth lens unit G4, and a fifth lens unit G5. In the body 4, the zoom lens system 1 is arranged on the front side, while the image sensor 2 is arranged on the rear side of the zoom lens system 1. On the rear side of the body 4, the liquid crystal display monitor 3 is arranged, while an optical image of a photographic object generated by the zoom lens system 1 is formed on an image surface S.

The lens barrel comprises a main barrel 5, a moving barrel 6 and a cylindrical cam 7. When the cylindrical cam 7 is rotated, the first lens unit G1, the second lens unit G2, the aperture diaphragm A and the third lens unit G3, the fourth lens unit G4, and the fifth lens unit G5 move to predetermined positions relative to the image sensor 2, so that zooming from a wide-angle limit to a telephoto limit is achieved. The fifth lens unit G5 is movable in an optical axis direction by a motor for focus adjustment.

As such, when the zoom lens system according to Embodiment 1 is employed in a digital still camera, a small digital still camera is obtained that has a high resolution and high capability of compensating the curvature of field and that has a short overall length of lens system at the time of non-use. Here, in the digital still camera shown in FIG. 16, any one of the zoom lens systems according to Embodiments 2 to 5 may be employed in place of the zoom lens system according to Embodiment 1. Further, the optical system of the digital still camera shown in FIG. 16 is applicable also to a digital video camera for moving images. In this case, moving images with high resolution can be acquired in addition to still images.

Here, the digital still camera according to the present Embodiment 6 has been described for a case that the employed zoom lens system 1 is a zoom lens system according to Embodiments 1 to 5. However, in these zoom lens systems, the entire zooming range need not be used. That is, in accordance with a desired zooming range, a range where satisfactory optical performance is obtained may exclusively be used. Then, the zoom lens system may be used as one having a lower magnification than the zoom lens system described in Embodiments 1 to 5.

Further, Embodiment 6 has been described for a case that the zoom lens system is applied to a lens barrel of so-called barrel retraction construction. However, the present invention is not limited to this. For example, the zoom lens system may be applied to a lens barrel of so-called bending configuration where a prism having an internal reflective surface or a front surface reflective mirror is arranged at an arbitrary position within the first lens unit G1 or the like. Further, in Embodiment 6, the zoom lens system may be applied to a so-called sliding lens barrel in which a part of the lens units constituting the zoom lens system like the entirety of the second lens unit G2, the entirety of the third lens unit G3, or alternatively a part of the second lens unit G2 or the third lens unit G3 is caused to escape from the optical axis at the time of barrel retraction.

An imaging device comprising a zoom lens system according to Embodiments 1 to 5, and an image sensor such as a CCD or a CMOS may be applied to a mobile telephone, a surveillance camera in a surveillance system, a Web camera, a vehicle-mounted camera or the like.

The following description is given for numerical examples in which the zoom lens system according to Embodiments 1 to 5 are implemented practically. In the numerical examples, the units of the length in the tables are all “mm”, while the units of the view angle are all “°”. Moreover, in the numerical examples, r is the radius of curvature, d is the axial distance, nd is the refractive index to the d-line, vd is the Abbe number to the d-line, and θgF is the partial dispersion ratio which is the ratio of a difference between a refractive index to the g-line and a refractive index to the F-line, to a difference between a refractive index to the F-line and a refractive index to the C-line. In the numerical examples, the surfaces marked with * are aspheric surfaces, and the aspheric surface configuration is defined by the following expression.

$$Z = \frac{{h}^{2} / r}{1 + \sqrt{1 - ( 1 + κ ) {( h / r )}^{2}}} + \sum {A}_{n} {h}^{n}$$

Here, h is a height relative to the optical axis, κ is a conic constant, and An is a n-th order aspherical coefficient.

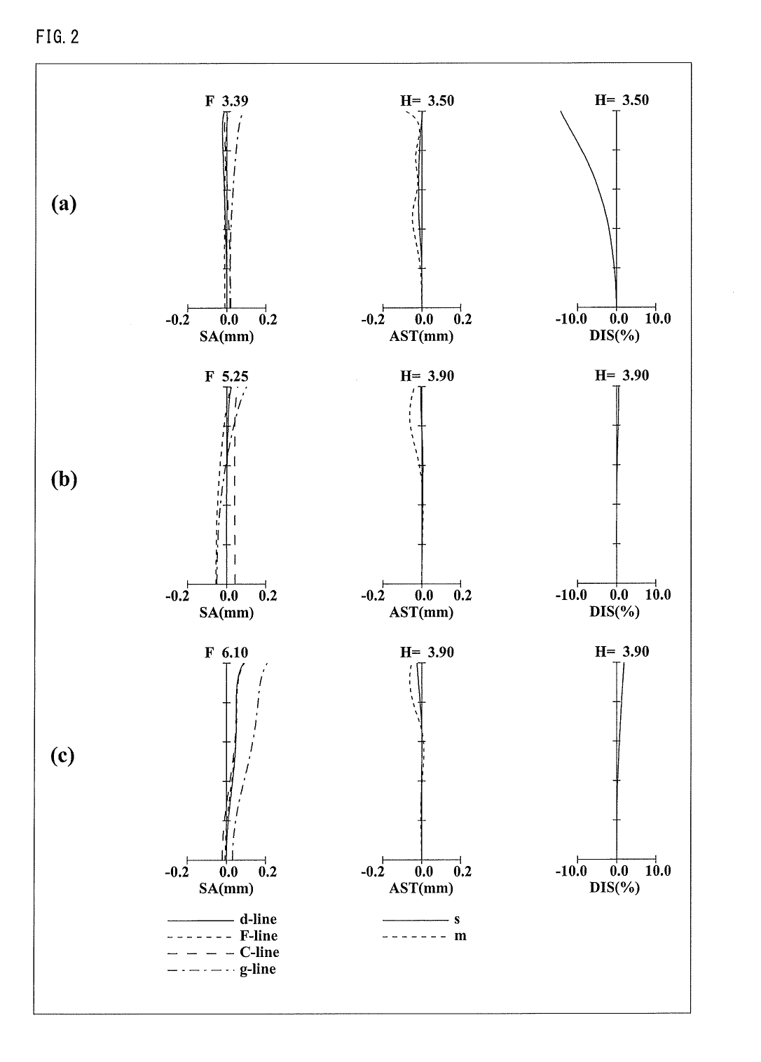

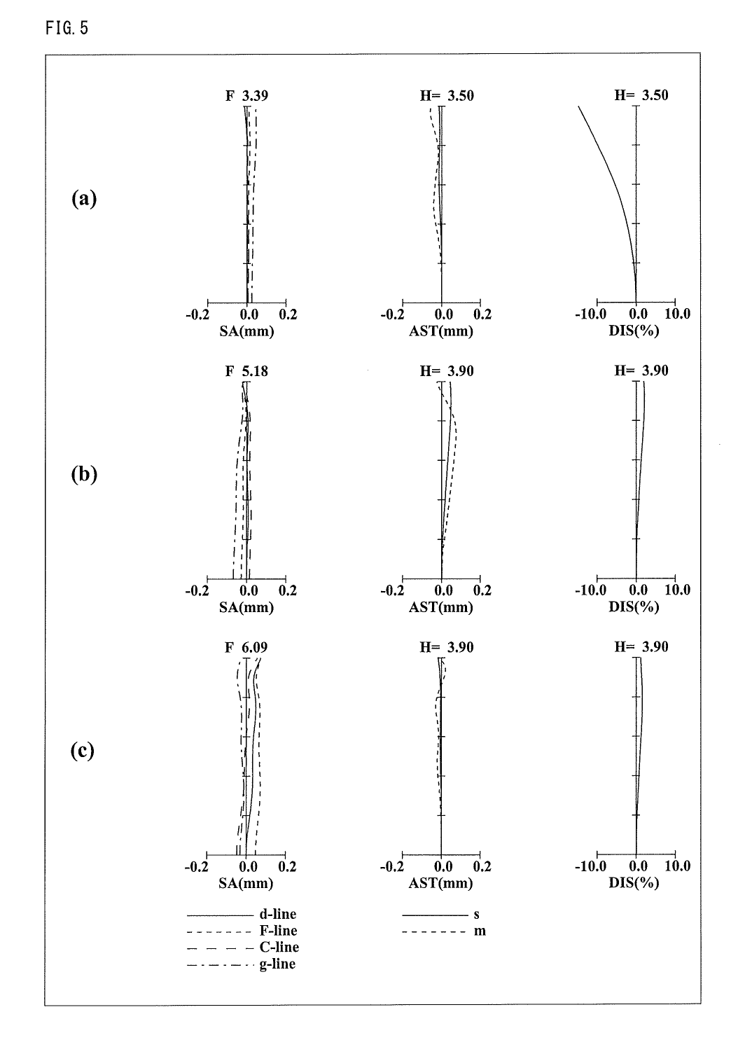

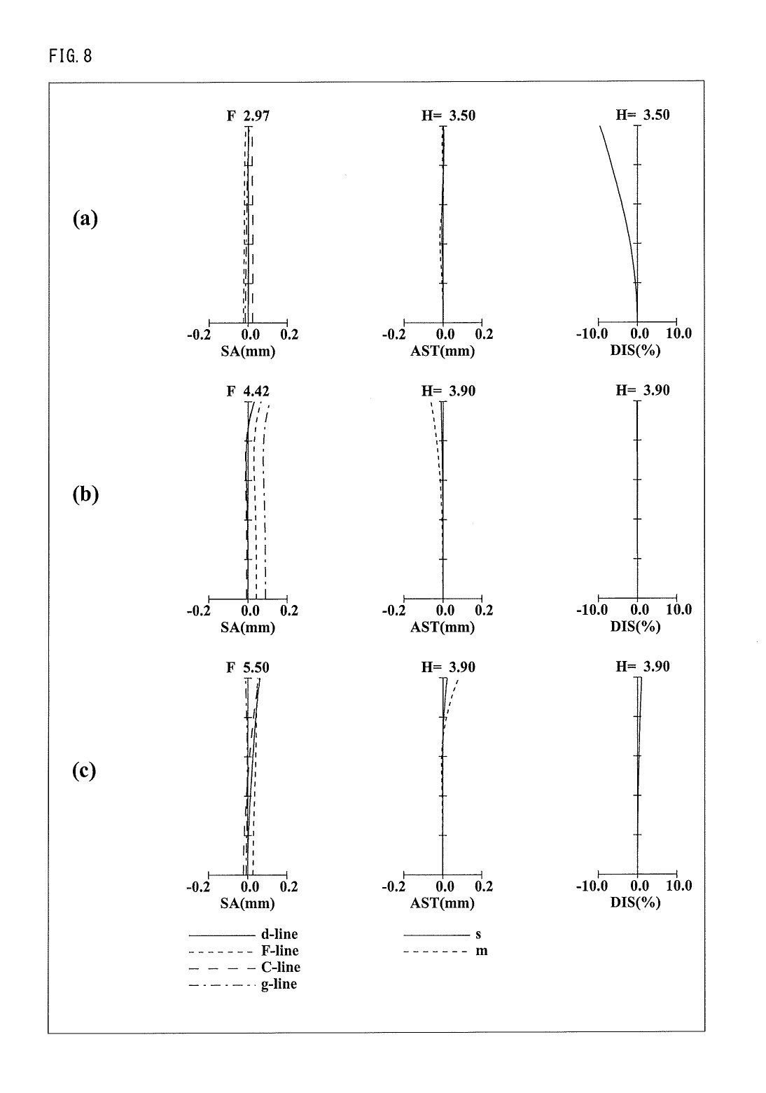

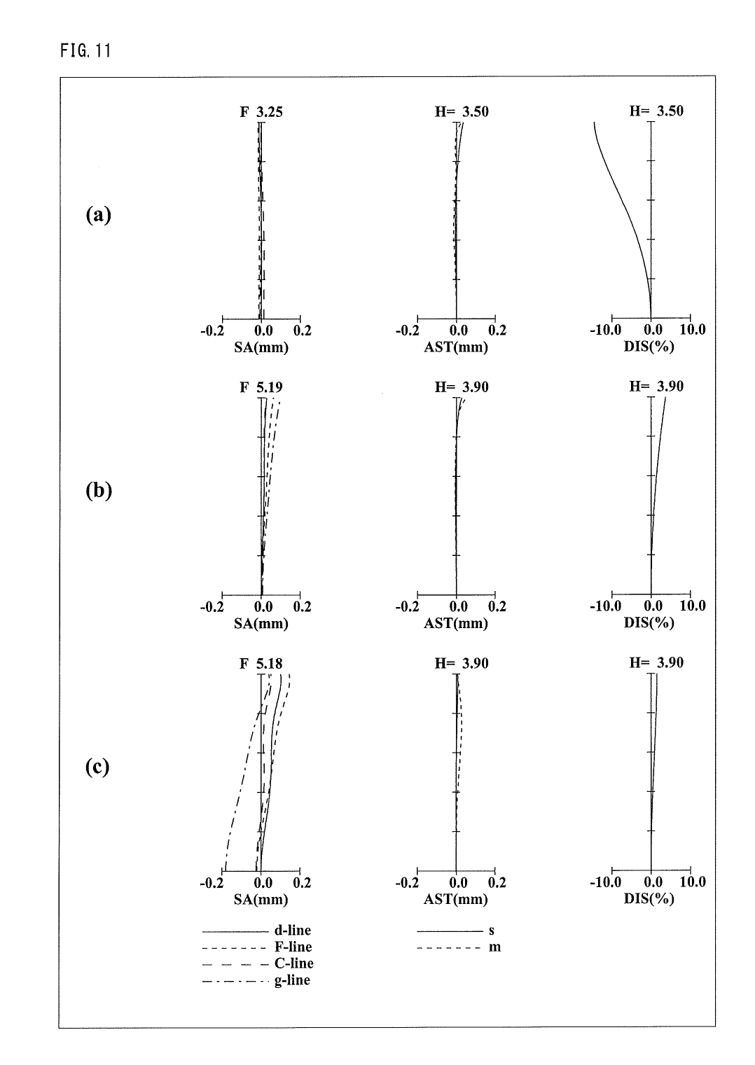

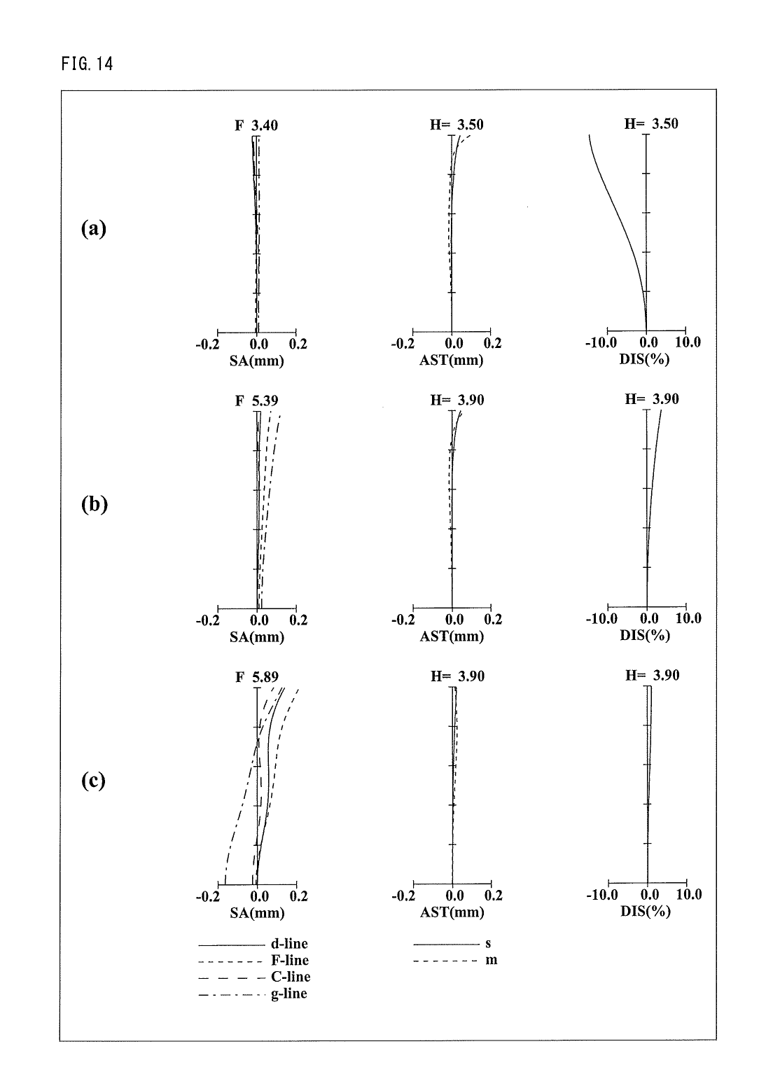

FIGS. 2, 5, 8, 11, and 14 are longitudinal aberration diagrams of the zoom lens systems according to Embodiments 1 to 5, respectively.

In each longitudinal aberration diagram, part (a) shows the aberration at a wide-angle limit, part (b) shows the aberration at a middle position, and part (c) shows the aberration at a telephoto limit. Each longitudinal aberration diagram, in order from the left-hand side, shows the spherical aberration (SA (mm)), the astigmatism (AST (mm)) and the distortion (DIS (%)). In each spherical aberration diagram, the vertical axis indicates the F-number (in each Fig., indicated as F), and the solid line, the short dash line, the long dash line and the one-dot dash line indicate the characteristics to the d-line, the F-line, the C-line and the g-line, respectively. In each astigmatism diagram, the vertical axis indicates the image height (in each Fig., indicated as H), and the solid line and the dash line indicate the characteristics to the sagittal plane (in each Fig., indicated as “s”) and the meridional plane (in each Fig., indicated as “m”), respectively. In each distortion diagram, the vertical axis indicates the image height (in each Fig., indicated as H).

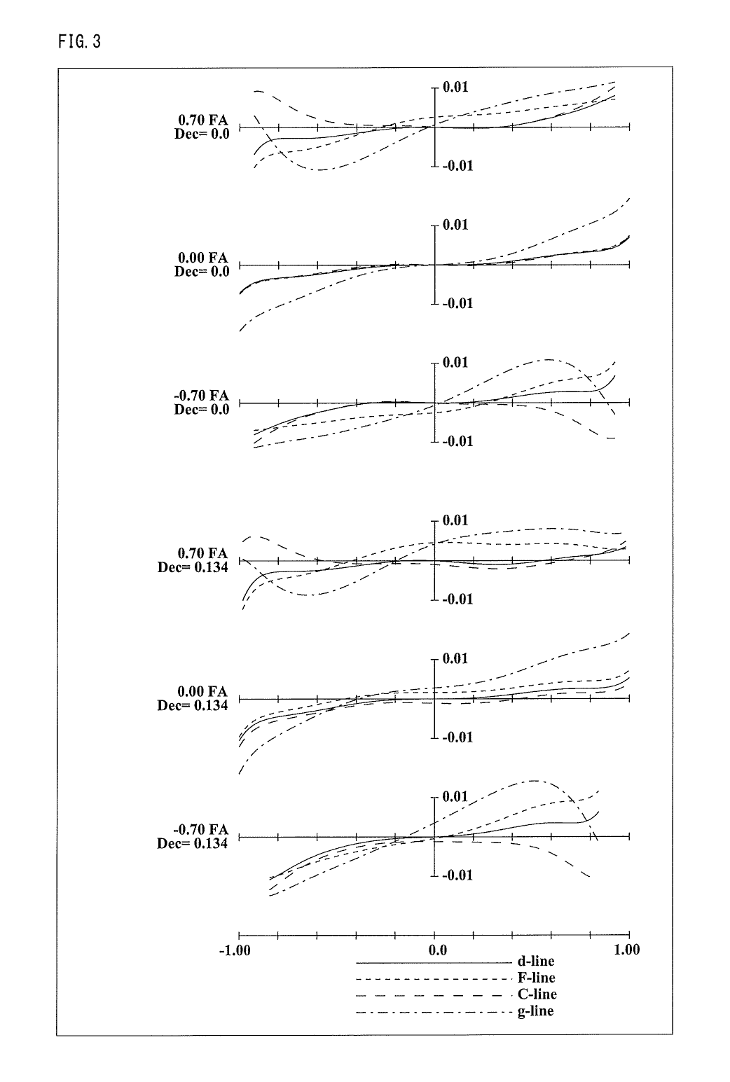

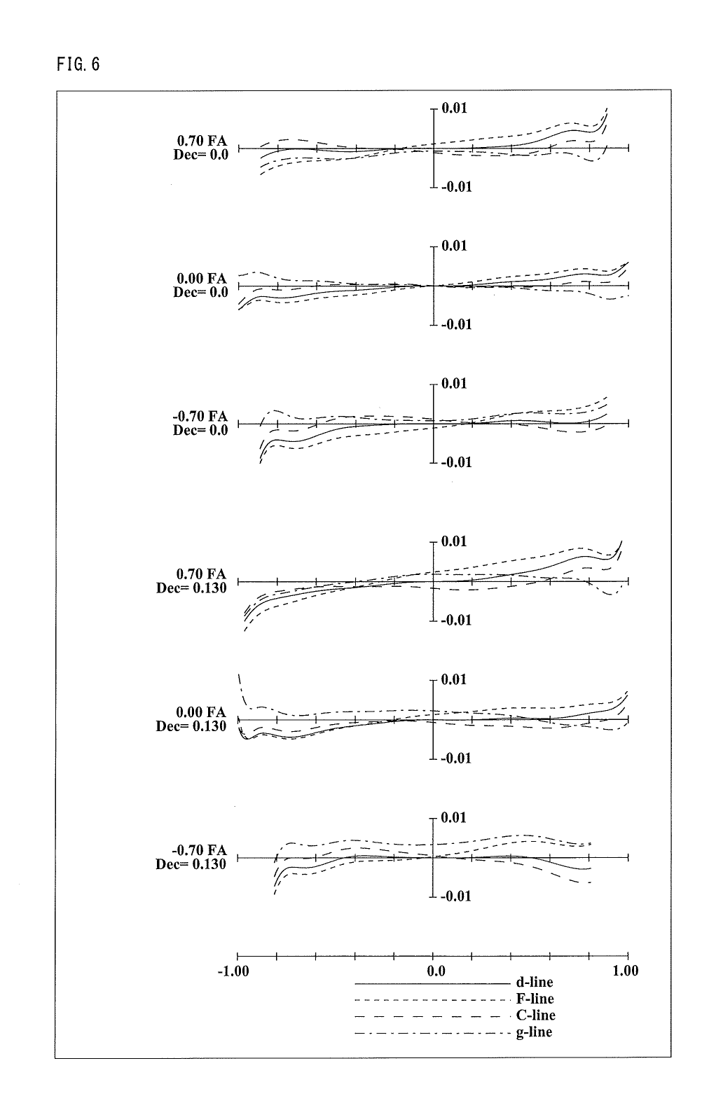

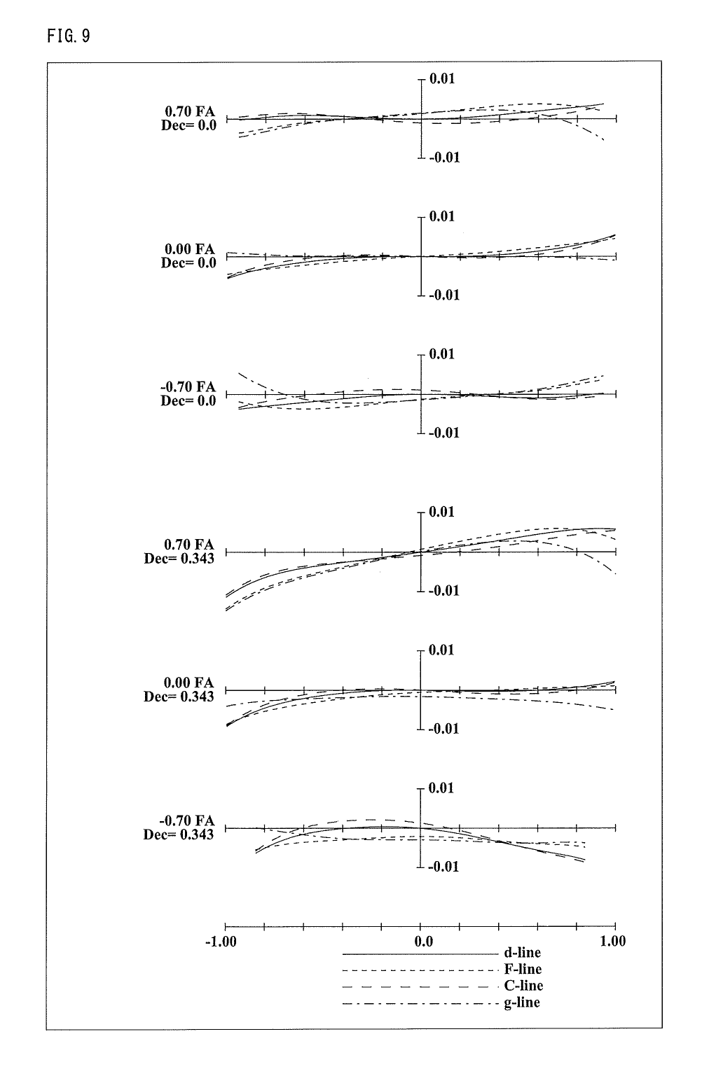

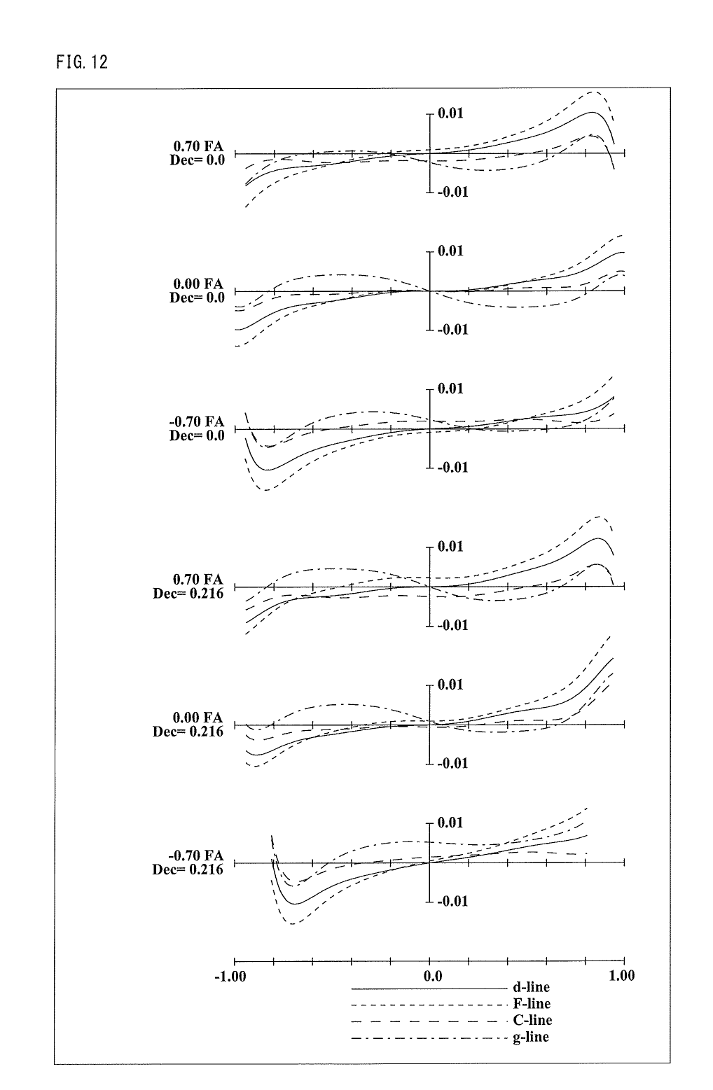

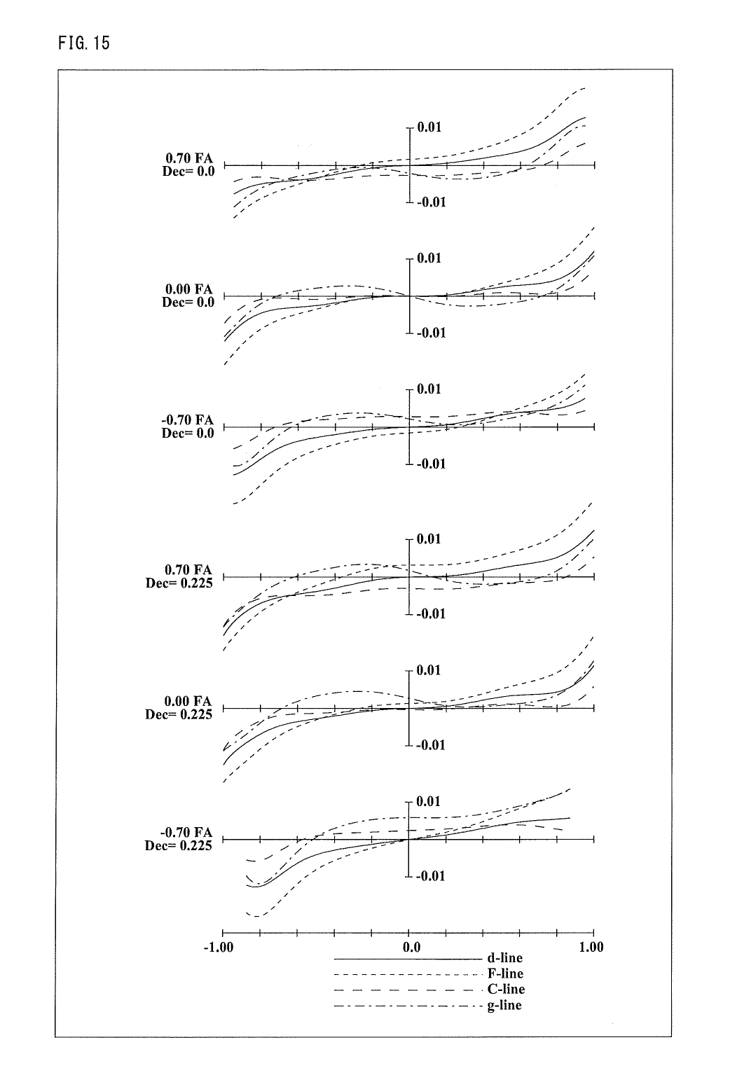

FIGS. 3, 6, 9, 12, and 15 are lateral aberration diagrams of the zoom lens systems at a telephoto limit according to Embodiments 1 to 5, respectively.

In each lateral aberration diagram, the aberration diagrams in the upper three parts correspond to a basic state where image blur compensation is not performed at a telephoto limit, while the aberration diagrams in the lower three parts correspond to an image blur compensation state where the entirety of the third lens unit G3 is moved by a predetermined amount in a direction perpendicular to the optical axis at a telephoto limit. Among the lateral aberration diagrams of a basic state, the upper part shows the lateral aberration at an image point of 70% of the maximum image height, the middle part shows the lateral aberration at the axial image point, and the lower part shows the lateral aberration at an image point of −70% of the maximum image height. Among the lateral aberration diagrams of an image blur compensation state, the upper part shows the lateral aberration at an image point of 70% of the maximum image height, the middle part shows the lateral aberration at the axial image point, and the lower part shows the lateral aberration at an image point of −70% of the maximum image height. In each lateral aberration diagram, the horizontal axis indicates the distance from the principal ray on the pupil surface, and the solid line, the short dash line, the long dash line and the one-dot dash line indicate the characteristics to the d-line, the F-line, the C-line and the g-line, respectively. In each lateral aberration diagram, the meridional plane is adopted as the plane containing the optical axis of the first lens unit G1 and the optical axis of the third lens unit G3.

Here, in the zoom lens system according to each example, the amount of movement of the third lens unit G3 in a direction perpendicular to the optical axis in an image blur compensation state at a telephoto limit is as follows.

| | Amount of movement |
|---|---|
| Example | (mm) |
| 1 | 0.134 |
| 2 | 0.130 |
| 3 | 0.343 |
| 4 | 0.216 |
| 5 | 0.225 |

Here, when the shooting distance is infinity, at a telephoto limit, the amount of image decentering in a case that the zoom lens system inclines by 0.3° is equal to the amount of image decentering in a case that the entirety of the third lens unit G3 displaces in parallel by each of the above-mentioned values in a direction perpendicular to the optical axis.

As seen from the lateral aberration diagrams, satisfactory symmetry is obtained in the lateral aberration at the axial image point. Further, when the lateral aberration at the +70% image point and the lateral aberration at the −70% image point are compared with each other in the basic state, all have a small degree of curvature and almost the same inclination in the aberration curve. Thus, decentering coma aberration and decentering astigmatism are small. This indicates that sufficient imaging performance is obtained even in the image blur compensation state. Further, when the image blur compensation angle of a zoom lens system is the same, the amount of parallel translation required for image blur compensation decreases with decreasing focal length of the entire zoom lens system. Thus, at arbitrary zoom positions, sufficient image blur compensation can be performed for image blur compensation angles up to 0.3° without degrading the imaging characteristics.

### Numerical Example 1

The zoom lens system of Numerical Example 1 corresponds to Embodiment 1 shown in FIG. 1. Table 1 shows the surface data of the zoom lens system of Numerical Example 1. Table 2 shows the aspherical data. Table 3 shows the various data.

TABLE 1
(Surface data)

| Surface number | r | d | nd | vd | θgF |
|---|---|---|---|---|---|
| Object surface | ∞ | | | | |
| 1* | 29.70650 | 0.10000 | 1.87806 | 13.1 | 0.751 |
| 2 | 24.56380 | 2.46240 | 1.62299 | 58.1 | |
| 3 | 568.86410 | 0.10000 | 1.59266 | 12.2 | 0.281 |
| 4* | 118.84240 | 0.15000 | | | |
| 5 | 22.06500 | 1.69490 | 1.80420 | 46.5 | |
| 6 | 51.65800 | Variable | | | |
| 7* | 36.60720 | 0.30000 | 1.80470 | 41.0 | |
| 8* | 4.73370 | 3.79350 | | | |
| 9 | −6.58260 | 0.30000 | 2.00100 | 29.1 | |
| 10 | −25.00380 | 0.10000 | | | |
| 11 | 65.93660 | 0.30000 | 1.94595 | 18.0 | |
| 12 | 65.93650 | 0.70000 | 1.75998 | 12.9 | 0.635 |
| 13* | −13.55230 | Variable | | | |
| 14(Diaphragm) | ∞ | 0.30000 | | | |
| 15* | 4.77550 | 2.18930 | 1.58332 | 59.1 | |
| 16* | 3671.38070 | 1.03840 | | | |
| 17 | 36.75970 | 1.07230 | 1.48749 | 70.4 | |
| 18 | −11.00890 | 0.40000 | 1.82115 | 24.1 | |
| 19* | 51.28740 | Variable | | | |
| 20 | 25.26620 | 0.50000 | 2.00100 | 29.1 | |
| 21 | 13.17010 | Variable | | | |
| 22* | 12.71540 | 1.59540 | 1.58332 | 59.1 | |
| 23* | −500.00000 | Variable | | | |
| 24 | ∞ | 0.80000 | 1.51680 | 64.2 | |
| 25 | ∞ | (BF) | | | |
| Image surface | ∞ | | | | |

TABLE 2
(Aspherical data)

Surface No. 1
K = 0.00000E+00, A4 = −8.81318E−06, A6 = 1.36962E−07,
A8 = −2.22579E−10 A10 = −8.16614E−12, A12 = 6.48512E−14
Surface No. 4
K = 0.00000E+00, A4 = −1.39198E−05, A6 = 2.85553E−07,
A8 = −1.26504E−09 A10 = −8.24286E−12, A12 = 1.01311E−13
Surface No. 7
K = 0.00000E+00, A4 = 1.16079E−04, A6 = −8.49496E−06,
A8 = 2.75168E−08 A10 = 2.84110E−09, A12 = 0.00000E+00
Surface No. 8
K = 0.00000E+00, A4 = −1.17693E−04, A6 = −5.25509E−05,
A8 = 4.69214E−06 A10 = −2.99414E−07, A12 = 0.00000E+00
Surface No. 13
K = 0.00000E+00, A4 = 5.96545E−06, A6 = 2.95922E−07,
A8 = −5.14738E−07 A10 = 8.84119E−08, A12 = −2.51908E−09
Surface No. 15
K = 0.00000E+00, A4 = −9.42499E−05, A6 = −9.72250E−06,
A8 = 4.33501E−07 A10 = 6.56678E−08, A12 = 0.00000E+00
Surface No. 16
K = 0.00000E+00, A4 = −1.06097E−05, A6 = −2.92325E−05,
A8 = 3.91073E−06 A10 = 0.00000E+00, A12 = 0.00000E+00
Surface No. 19
K = 0.00000E+00, A4 = 2.13809E−03, A6 = 1.20859E−04,
A8 = −2.39553E−06 A10 = 1.05580E−06, A12 = 0.00000E+00
Surface No. 22
K = 0.00000E+00, A4 = 2.01115E−04, A6 = −2.48171E−05,
A8 = 3.57944E−07 A10 = 9.85878E−08, A12 = −4.00162E−09
Surface No. 23
K = 0.00000E+00, A4 = 8.95379E−05, A6 = −7.95509E−06,
A8 = −2.21602E−06 A10 = 2.52415E−07, A12 = −7.34174E−09

TABLE 3
(Various data)
Zooming ratio 15.15867

| | Wide-angle | Middle | Telephoto |
|---|---|---|---|
| | limit | position | limit |
| Focal length | 4.6502 | 18.6022 | 70.4907 |
| F-number | 3.39057 | 5.24652 | 6.10105 |
| View angle | 41.3087 | 11.7777 | 3.1090 |
| Image height | 3.5000 | 3.9000 | 3.9000 |
| Overall length | 46.1304 | 51.8230 | 55.9931 |
| of lens system | | | |
| BF | 0.52208 | 0.51861 | 0.47302 |
| d6 | 0.3001 | 9.2434 | 17.2269 |
| d13 | 15.6948 | 5.3343 | 0.5527 |
| d19 | 1.0301 | 8.1434 | 9.1572 |
| d21 | 5.8489 | 2.8261 | 7.8205 |
| d23 | 4.8382 | 7.8610 | 2.8666 |
| Entrance pupil | 10.1397 | 34.3165 | 110.3074 |
| position | | | |
| Exit pupil | −24.1907 | −31.8980 | −76.3357 |
| position | | | |
| Front principal | 13.9149 | 42.2439 | 116.1057 |
| points position | | | |
| Back principal | 41.4802 | 33.2208 | −14.4976 |
| points position | | | |

Zoom lens unit data

| Lens | Initial | Focal |
|---|---|---|
| unit | surface No. | length |
| 1 | 1 | 28.40638 |
| 2 | 7 | −5.02475 |
| 3 | 14 | 9.66052 |
| 4 | 20 | −28.06235 |
| 5 | 22 | 21.28212 |

### Numerical Example 2

The zoom lens system of Numerical Example 2 corresponds to Embodiment 2 shown in FIG. 4. Table 4 shows the surface data of the zoom lens system of Numerical Example 2. Table 5 shows the aspherical data. Table 6 shows the various data.

TABLE 4
(Surface data)

| Surface number | r | d | nd | vd | θgF |
|---|---|---|---|---|---|
| Object surface | ∞ | | | | |
| 1 | 42.38020 | 0.75000 | 1.84666 | 23.8 | |
| 2 | 28.20350 | 3.19860 | 1.49700 | 81.6 | |
| 3 | −120.85030 | 0.10000 | 1.51632 | 27.2 | 0.368 |
| 4* | −934.13670 | 0.15000 | | | |
| 5 | 25.41120 | 1.99330 | 1.72916 | 54.7 | |
| 6 | 76.79770 | Variable | | | |
| 7* | 63.49090 | 0.50000 | 1.88202 | 37.2 | |
| 8* | 5.34120 | 3.43580 | | | |
| 9 | −7.39600 | 0.30000 | 1.72916 | 54.7 | |
| 10 | −73.31830 | 0.16940 | | | |
| 11 | 33.81680 | 1.19740 | 1.94595 | 18.0 | |
| 12 | −24.77490 | Variable | | | |
| 13(Diaphragm) | ∞ | 0.30000 | | | |
| 14* | 6.27400 | 2.02950 | 1.58332 | 59.1 | |
| 15* | −19.50330 | 0.41250 | | | |
| 16 | 9.40980 | 1.29290 | 1.51680 | 64.2 | |
| 17 | −54.86340 | 0.30000 | 1.90366 | 31.3 | |
| 18 | 5.44290 | 0.40440 | | | |
| 19 | 13.10020 | 2.00000 | 1.56341 | 51.8 | 0.617 |
| 20 | −13.38140 | Variable | | | |
| 21 | 71.63730 | 0.50000 | 1.88300 | 40.8 | |
| 22 | 9.51570 | Variable | | | |
| 23* | 9.16580 | 2.14530 | 1.52996 | 55.8 | |
| 24* | −68.38470 | 3.00520 | | | |
| 25 | ∞ | 0.80000 | 1.51680 | 64.2 | |
| 26 | ∞ | (BF) | | | |
| Image surface | ∞ | | | | |

TABLE 5
(Aspherical data)

Surface No. 4
K = 0.00000E+00, A4 = 1.32389E−08, A6 = 4.41971E−09,
A8 = −3.63943E−11 A10 = 1.07017E−13, A12 = 0.00000E+00
Surface No. 7
K = 0.00000E+00, A4 = −1.31117E−04, A6 = 1.36489E−05,
A8 = −2.74551E−07 A10 = 1.06774E−09, A12 = 0.00000E+00
Surface No. 8
K = 0.00000E+00, A4 = −2.82842E−04, A6 = −7.36196E−06,
A8 = 2.11582E−06 A10 = −2.63569E−08, A12 = 0.00000E+00
Surface No. 14
K = 0.00000E+00, A4 = −6.70273E−04, A6 = −1.83958E−05,
A8 = −5.37613E−06 A10 = 5.45549E−07, A12 = −4.61749E−08
Surface No. 15
K = 0.00000E+00, A4 = −6.62305E−05, A6 = −3.51598E−05,
A8 = −1.06720E−06 A10 = −4.39089E−08, A12 = −1.48226E−08
Surface No. 23
K = 0.00000E+00, A4 = 2.56862E−05, A6 = 1.90183E−05,
A8 = −2.60216E−06 A10 = 1.57043E−07, A12 = −5.24384E−09
Surface No. 24
K = 0.00000E+00, A4 = 2.44391E−04, A6 = −1.14093E−05,
A8 = 6.63655E−07 A10 = −6.77964E−08, A12 = 0.00000E+00

TABLE 6
(Various data)
Zooming ratio 18.39413

| | Wide-angle | Middle | Telephoto |
|---|---|---|---|
| | limit | position | limit |
| Focal length | 4.6547 | 19.9902 | 85.6192 |
| F-number | 3.39391 | 5.17510 | 6.09207 |
| View angle | 41.4478 | 10.8352 | 2.5777 |
| Image height | 3.5000 | 3.9000 | 3.9000 |
| Overall length | 50.0856 | 57.8260 | 69.0645 |
| of lens system | | | |
| BF | 0.53837 | 0.55127 | 0.55335 |
| d6 | 0.3000 | 12.8221 | 23.5721 |
| d12 | 17.7000 | 5.7907 | 0.7777 |
| d20 | 4.5629 | 10.5422 | 8.7641 |
| d22 | 2.0000 | 3.1354 | 10.4130 |
| Entrance pupil | 11.3154 | 42.4824 | 142.4477 |
| position | | | |
| Exit pupil | −19.9148 | −35.3447 | 146.0949 |
| position | | | |
| Front principal | 14.9108 | 51.3402 | 278.4351 |
| points position | | | |
| Back principal | 45.4309 | 37.8358 | −16.5547 |
| points position | | | |

Zoom lens unit data

| Lens | Initial | Focal |
|---|---|---|
| unit | surface No. | length |
| 1 | 1 | 36.82740 |
| 2 | 7 | −5.81682 |
| 3 | 13 | 9.96228 |
| 4 | 21 | −12.47438 |
| 5 | 23 | 15.39867 |

### Numerical Example 3

The zoom lens system of Numerical Example 3 corresponds to Embodiment 3 shown in FIG. 7. Table 7 shows the surface data of the zoom lens system of Numerical Example 3. Table 8 shows the aspherical data. Table 9 shows the various data.

TABLE 7
(Surface data)

| Surface number | r | d | nd | vd | θgF |
|---|---|---|---|---|---|
| Object surface | ∞ | | | | |
| 1 | 134.05430 | 1.25000 | 1.90366 | 31.3 | |
| 2 | 58.58310 | 3.92650 | 1.48749 | 70.4 | |
| 3 | −345.87030 | 0.15000 | | | |
| 4 | 62.64410 | 3.17220 | 1.49700 | 81.6 | |
| 5 | 928.61370 | 0.15000 | | | |
| 6 | 35.85380 | 3.48220 | 1.49700 | 81.6 | |
| 7 | 96.24640 | 0.10000 | 1.73531 | 7.3 | 0.249 |
| 8* | 92.87380 | Variable | | | |
| 9* | 5000.00000 | 1.20000 | 1.80470 | 41.0 | |
| 10* | 6.92920 | 4.10810 | | | |
| 11 | −28.66730 | 0.70000 | 1.81600 | 46.6 | |
| 12 | 25.09380 | 1.19090 | 1.87806 | 13.1 | 0.751 |
| 13 | 42.31840 | 0.17220 | | | |
| 14 | 16.85920 | 1.60990 | 1.92286 | 20.9 | |
| 15 | 64.60840 | Variable | | | |
| 16(Diaphragm) | ∞ | 1.20000 | | | |
| 17* | 10.57080 | 1.68880 | 1.58332 | 59.1 | |
| 18 | −136.06150 | 2.50300 | | | |
| 19 | 13.57870 | 1.92630 | 1.59270 | 35.4 | |
| 20 | 129.00090 | 0.70000 | 1.80518 | 25.5 | |
| 21 | 8.63070 | 0.55020 | | | |
| 22 | 36.43090 | 1.22270 | 1.49700 | 81.6 | |
| 23 | −27.97960 | Variable | | | |
| 24 | 18.02480 | 1.91230 | 1.60625 | 63.7 | |
| 25 | −36.82450 | 0.60000 | 1.90366 | 31.3 | |
| 26 | −143.90830 | Variable | | | |
| 27 | ∞ | 0.80000 | 1.51680 | 64.2 | |
| 28 | ∞ | (BF) | | | |
| Image surface | ∞ | | | | |

TABLE 8
(Aspherical data)

Surface No. 8
K = 0.00000E+00, A4 = −5.34727E−08, A6 = −2.34868E−11,
A8 = −5.18677E−14 A10 = 7.86378E−16, A12 = −1.71401E−18,
A14 = 0.00000E+00, A16 = 0.00000E+00
Surface No. 9
K = 0.00000E+00, A4 = 1.23682E−04, A6 = −3.41947E−06,
A8 = 5.51356E−08 A10 = −5.65687E−10, A12 = 2.48801E−12,
A14 = 0.00000E+00, A16 = 0.00000E+00
Surface No. 10
K = 2.59626E−02, A4 = 6.18363E−05, A6 = −3.43193E−06,
A8 = −6.08297E−08 A10 = 4.19879E−09, A12 = −1.53825E−10,
A14 = 0.00000E+00, A16 = 0.00000E+00
Surface No. 17
K = 0.00000E+00, A4 = −1.05465E−04, A6 = −1.72913E−07,
A8 = −7.24537E−09 A10 = −9.19758E−10, A12 = 4.63596E−11,
A14 = −1.08341E−13, A16 = −2.03834E−14

TABLE 9
(Various data)
Zooming ratio 22.92464

| | Wide-angle | Middle | Telephoto |
|---|---|---|---|
| | limit | position | limit |
| Focal length | 4.6381 | 22.1363 | 106.3269 |
| F-number | 2.97215 | 4.42236 | 5.50134 |
| View angle | 39.8815 | 10.0091 | 2.0791 |
| Image height | 3.5000 | 3.9000 | 3.9000 |
| Overall length | 83.1528 | 98.0556 | 110.1625 |
| of lens system | | | |
| BF | 0.92018 | 1.11389 | 1.14454 |
| d8 | 0.5323 | 18.1321 | 40.7197 |
| d15 | 32.4415 | 7.7292 | 2.0400 |
| d23 | 7.8164 | 20.0466 | 23.9430 |
| d26 | 7.1271 | 16.7185 | 8.0000 |
| Entrance pupil | 19.4599 | 58.7653 | 334.3249 |
| position | | | |
| Exit pupil | −37.5124 | −218.4226 | −2656.5071 |
| position | | | |
| Front principal | 23.5382 | 78.6696 | 436.3980 |
| points position | | | |
| Back principal | 78.5147 | 75.9193 | 3.8356 |
| points position | | | |

Zoom lens unit data

| Lens | Initial | Focal |
|---|---|---|
| unit | surface No. | length |
| 1 | 1 | 58.95569 |
| 2 | 9 | −8.20972 |
| 3 | 16 | 18.53893 |
| 4 | 24 | 31.38930 |

### Numerical Example 4

The zoom lens system of Numerical Example 4 corresponds to Embodiment 4 shown in FIG. 10. Table 10 shows the surface data of the zoom lens system of Numerical Example 4. Table 11 shows the aspherical data. Table 12 shows the various data.

TABLE 10
(Surface data)

| Surface number | r | d | nd | vd | θgF |
|---|---|---|---|---|---|
| Object surface | ∞ | | | | |
| 1 | 76.01860 | 1.25000 | 1.90366 | 31.3 | |
| 2 | 36.48280 | 4.69020 | 1.49700 | 81.6 | |
| 3 | 446.15950 | 0.15000 | | | |
| 4 | 39.63210 | 3.78650 | 1.59282 | 68.6 | |
| 5 | 111.00100 | 0.15000 | | | |
| 6 | 47.81470 | 3.03350 | 1.72916 | 54.7 | |
| 7 | 201.43900 | 0.10000 | 1.59266 | 12.2 | 0.281 |
| 8 | 162.04320 | Variable | | | |
| 9* | −99.67690 | 0.50000 | 1.84973 | 40.6 | |
| 10* | 13.85340 | 3.77750 | | | |
| 11 | −19.14060 | 0.70000 | 1.88300 | 40.8 | |
| 12 | 33.32610 | 0.40060 | | | |
| 13 | 25.35260 | 2.46450 | 2.00272 | 19.3 | |
| 14 | −21.38770 | 0.33610 | | | |
| 15 | −17.27840 | 0.70000 | 1.88300 | 40.8 | |
| 16 | 71.41870 | Variable | | | |
| 17(Diaphragm) | ∞ | 0.30000 | | | |
| 18* | 7.57730 | 1.95620 | 1.66547 | 55.2 | |
| 19* | 17.06320 | 0.54190 | | | |
| 20 | 11.58000 | 1.66030 | 1.49700 | 81.6 | |
| 21 | −41.30770 | 0.42260 | | | |
| 22 | 12.36400 | 3.15230 | 1.49700 | 81.6 | |
| 23 | −5.46160 | 0.40000 | 1.90366 | 31.3 | |
| 24 | 9.09110 | 1.76050 | | | |
| 25 | 16.06150 | 1.34770 | 1.80610 | 33.3 | |
| 26 | −15.17300 | Variable | | | |
| 27* | −203.25460 | 0.40000 | 1.52500 | 70.4 | |
| 28* | 5.82380 | Variable | | | |
| 29* | 58.06480 | 2.29070 | 1.56341 | 51.8 | 0.617 |
| 30* | −8.98050 | Variable | | | |
| 31 | ∞ | 0.80000 | 1.51680 | 64.2 | |
| 32 | ∞ | (BF) | | | |
| Image surface | ∞ | | | | |

TABLE 11
(Aspherical data)

Surface No. 9
K = 0.00000E+00, A4 = −2.74460E−05, A6 = 3.62641E−06,
A8 = −5.63672E−08 A10 = 4.45930E−10, A12 = −1.49485E−12
Surface No. 10
K = −6.75603E−01, A4 = −6.48477E−06, A6 = 2.72516E−06,
A8 = 5.93486E−08 A10 = −1.71182E−09, A12 = 1.96444E−11
Surface No. 18
K = 0.00000E+00, A4 = 2.17801E−04, A6 = 3.75171E−06,
A8 = 6.95030E−08 A10 = 6.98376E−09, A12 = 0.00000E+00
Surface No. 19
K = 0.00000E+00, A4 = 4.31852E−04, A6 = 2.03930E−06,
A8 = 3.10343E−07 A10 = 0.00000E+00, A12 = 0.00000E+00
Surface No. 27
K = 0.00000E+00, A4 = 8.40146E−04, A6 = −9.49865E−05,
A8 = 3.95053E−06 A10 = −5.67656E−08, A12 = 0.00000E+00
Surface No. 28
K = 0.00000E+00, A4 = 1.04781E−03, A6 = −7.21402E−05,
A8 = 1.75965E−06 A10 = 0.00000E+00, A12 = 0.00000E+00
Surface No. 29
K = 0.00000E+00, A4 = −2.97914E−05, A6 = −1.35594E−06,
A8 = 6.25049E−07 A10 = 0.00000E+00, A12 = 0.00000E+00
Surface No. 30
K = 0.00000E+00, A4 = 2.90876E−04, A6 = −7.76734E−06,
A8 = 3.96245E−07 A10 = 1.03549E−08, A12 = 0.00000E+00

TABLE 12
(Various data)
Zooming ratio 29.05322

| | Wide-angle | Middle | Telephoto |
|---|---|---|---|
| | limit | position | limit |
| Focal length | 4.4196 | 23.8341 | 128.4037 |
| F-number | 3.25179 | 5.19257 | 5.17514 |
| View angle | 42.8228 | 8.9659 | 1.7146 |
| Image height | 3.5000 | 3.9000 | 3.9000 |
| Overall length | 78.7137 | 85.5517 | 87.3218 |
| of lens system | | | |
| BF | 0.96385 | 0.96241 | 0.94169 |
| d8 | 0.3346 | 20.9846 | 32.4178 |
| d16 | 32.9046 | 13.4289 | 0.7477 |
| d26 | 1.2824 | 4.5970 | 4.9031 |
| d28 | 2.5236 | 6.4821 | 10.4904 |
| d30 | 3.6335 | 2.0256 | 0.7500 |
| Entrance pupil | 21.2153 | 97.5618 | 259.1234 |
| position | | | |
| Exit pupil | −37.1146 | 560.2721 | 56.7915 |
| position | | | |
| Front principal | 25.1220 | 122.4116 | 682.7385 |
| points position | | | |
| Back principal | 74.2940 | 61.7176 | −41.0819 |
| points position | | | |

Zoom lens unit data

| Lens | Initial | Focal |
|---|---|---|
| unit | surface No. | length |
| 1 | 1 | 49.93879 |
| 2 | 9 | −7.40008 |
| 3 | 17 | 11.86586 |
| 4 | 27 | −10.77686 |
| 5 | 29 | 13.97659 |

### Numerical Example 5

The zoom lens system of Numerical Example 5 corresponds to Embodiment 5 shown in FIG. 13. Table 13 shows the surface data of the zoom lens system of Numerical Example 5. Table 14 shows the aspherical data. Table 15 shows the various data.

TABLE 13
(Surface data)

| Surface number | r | d | nd | vd | θgF |
|---|---|---|---|---|---|
| Object surface | ∞ | | | | |
| 1 | 79.87440 | 1.25000 | 1.90366 | 31.3 | |
| 2 | 37.29730 | 4.99400 | 1.49700 | 81.6 | |
| 3 | 612.59810 | 0.15000 | | | |
| 4 | 40.18970 | 4.09900 | 1.59282 | 68.6 | |
| 5 | 119.10730 | 0.15000 | | | |
| 6 | 47.92730 | 3.19090 | 1.72916 | 54.7 | |
| 7 | 190.51870 | 0.10000 | 1.59266 | 12.2 | 0.281 |
| 8 | 157.88680 | Variable | | | |
| 9* | −102.10760 | 0.50000 | 1.84973 | 40.6 | |
| 10* | 12.79970 | 4.11210 | | | |
| 11 | −17.98280 | 0.70000 | 1.88300 | 40.8 | |
| 12 | 46.38300 | 0.23950 | | | |
| 13 | 26.15370 | 2.53620 | 2.00272 | 19.3 | |
| 14 | −20.76930 | 0.28550 | | | |
| 15 | −17.74290 | 0.70000 | 1.88300 | 40.8 | |
| 16 | 64.94080 | Variable | | | |
| 17(Diaphragm) | ∞ | 0.30000 | | | |
| 18* | 7.46880 | 1.94280 | 1.66547 | 55.2 | |
| 19* | 16.50910 | 0.48810 | | | |
| 20 | 11.08520 | 1.53370 | 1.49700 | 81.6 | |
| 21 | −49.50080 | 0.46280 | | | |
| 22 | 12.99500 | 3.10410 | 1.49700 | 81.6 | |
| 23 | −5.30970 | 0.40000 | 1.90366 | 31.3 | |
| 24 | 8.46730 | 1.50860 | | | |
| 25 | 14.08340 | 1.44030 | 1.80610 | 33.3 | |
| 26 | −14.44130 | Variable | | | |
| 27* | −67.54320 | 0.40000 | 1.52500 | 70.4 | |
| 28* | 6.01400 | Variable | | | |
| 29* | 37.53130 | 2.19240 | 1.56341 | 51.8 | 0.617 |
| 30* | −10.23040 | Variable | | | |
| 31 | ∞ | 0.80000 | 1.51680 | 64.2 | |
| 32 | ∞ | (BF) | | | |
| Image surface | ∞ | | | | |

TABLE 14
(Aspherical data)

Surface No. 9
K = 0.00000E+00, A4 = −2.31959E−05, A6 = 3.59038E−06,
A8 = −5.70697E−08 A10 = 4.42272E−10, A12 = −1.44436E−12
Surface No. 10
K = −5.24645E−01, A4 = 2.17728E−06, A6 = 2.75617E−06,
A8 = 6.53795E−08 A10 = −1.73913E−09, A12 = 1.96444E−11
Surface No. 18
K = 0.00000E+00, A4 = 2.21368E−04, A6 = 2.99781E−06,
A8 = 9.71982E−08 A10 = 5.99213E−09, A12 = 0.00000E+00
Surface No. 19
K = 0.00000E+00, A4 = 4.23871E−04, A6 = 8.03867E−07,
A8 = 2.86598E−07 A10 = 0.00000E+00, A12 = 0.00000E+00
Surface No. 27
K = 0.00000E+00, A4 = 9.27380E−04, A6 = −9.10192E−05,
A8 = 4.32577E−06 A10 = −6.73519E−08, A12 = 0.00000E+00
Surface No. 28
K = 0.00000E+00, A4 = 9.60767E−04, A6 = −7.27381E−05,
A8 = 2.42562E−06 A10 = 0.00000E+00, A12 = 0.00000E+00
Surface No. 29
K = 0.00000E+00, A4 = −4.83077E−05, A6 = −3.60910E−06,
A8 = 4.17679E−07 A10 = 0.00000E+00, A12 = 0.00000E+00
Surface No. 30
K = 0.00000E+00, A4 = 2.29305E−04, A6 = −9.52975E−06,
A8 = 4.61233E−07 A10 = 9.85577E−10, A12 = 0.00000E+00

TABLE 15
(Various data)
Zooming ratio 34.33482

| | Wide-angle | Middle | Telephoto |
|---|---|---|---|
| | limit | position | limit |
| Focal length | 4.3974 | 26.1503 | 150.9852 |
| F-number | 3.40359 | 5.39377 | 5.89240 |
| View angle | 42.9587 | 8.1825 | 1.4646 |
| Image height | 3.5000 | 3.9000 | 3.9000 |
| Overall length | 82.4376 | 89.0384 | 91.1565 |
| of lens system | | | |
| BF | 0.98022 | 0.95964 | 0.95334 |
| d8 | 0.3484 | 22.3873 | 32.6911 |
| d16 | 35.0212 | 14.1102 | 0.7564 |
| d26 | 1.1939 | 4.4862 | 4.4097 |
| d28 | 3.3065 | 7.3343 | 14.0149 |
| d30 | 4.0074 | 2.1808 | 0.7511 |
| Entrance pupil | 21.8240 | 111.8670 | 275.0833 |
| position | | | |
| Exit pupil | −39.1242 | 702.8651 | 43.1125 |
| position | | | |
| Front principal | 25.7393 | 138.9915 | 966.7937 |
| points position | | | |
| Back principal | 78.0402 | 62.8881 | −59.8286 |
| points position | | | |

Zoom lens unit data

| Lens | Initial | Focal |
|---|---|---|
| unit | surface No. | length |
| 1 | 1 | 50.01099 |
| 2 | 9 | −7.35865 |
| 3 | 17 | 11.85311 |
| 4 | 27 | −10.49901 |
| 5 | 29 | 14.50862 |

The following Table 16 shows the corresponding values to the individual conditions in the zoom lens systems of each of Numerical Examples.

TABLE 16
(Values corresponding to conditions)

| | Lens | Condition | | | | | |
|---|---|---|---|---|---|---|---|
| Numerical | ele- | (1) | | | | | |
| Example | ment | I | II | (2) | (7) | ω_{W} | f_{T}/f_{W} |
| 1 | L1 | −0.0547 | — | −0.1031 | −0.0070 | 82.62 | 15.16 |
| | L3 | 0.4208 | — | 0.3698 | −0.0067 | | |
| | L8 | 0.0619 | — | 0.0131 | 0.0890 | | |
| 2 | L3 | — | 0.3682 | 0.2335 | −0.0072 | 82.90 | 18.39 |
| | L11 | — | 0.6173 | −0.0957 | 0.1511 | | |
| 3 | L5 | 0.4894 | — | 0.4171 | −0.0004 | 79.76 | 22.92 |
| | L8 | −0.0547 | — | −0.1031 | 0.0162 | | |
| 4 | L5 | 0.4208 | — | 0.3698 | −0.0012 | 85.65 | 29.05 |
| | L16 | — | 0.6173 | −0.0957 | 0.1286 | | |
| 5 | L5 | 0.4208 | — | 0.3698 | −0.0011 | 85.92 | 34.33 |
| | L16 | — | 0.6173 | −0.0957 | 0.1244 | | |

| | |
|---|---|
| Numerical | Condition |

| Example | (3) | (4) | (5) | (6) |
|---|---|---|---|---|
| 1 | 0.95 | 0.48 | −14.03 | 12.83 |
| 2 | 0.96 | 0.51 | −14.72 | 15.28 |
| 3 | 1.23 | 0.66 | −12.95 | 11.84 |
| 4 | 0.77 | 0.44 | −17.35 | 14.46 |
| 5 | 0.68 | 0.37 | −20.52 | 16.64 |

The following Table 17 shows the composition of each fine particle dispersed material and the optical properties of the fine particle dispersed material. The optical properties are the refractive index (nd) to the d-line, the Abbe number (vd) to the d-line and the partial dispersion ratio (θgF) which is the ratio of a difference between a refractive index to the g-line and a refractive index to the F-line, to a difference between a refractive index to the F-line and a refractive index to the C-line. The materials used in each Numerical Example are exemplified as the fine particle dispersed materials shown in Table 17.

TABLE 17
(Fine particle dispersed materials)

| | Inorganic particles | | | | | |
|---|---|---|---|---|---|---|
| | | Volume | Fine particle dispersed material | | | Numerical Example |
| Resin | Kinds | fraction | nd | vd | θgF | (Lens element) |
| Cycloolefin | ZrO₂ | 0.05 | 1.56341 | 51.8 | 0.617 | 2(L11), 4(L16), 5(L16) |
| polymer | | 0.2 | 1.65971 | 44.8 | 0.695 | |
| | | 0.5 | 1.83722 | 39.0 | 0.761 | |
| | BaTiO₃ | 0.05 | 1.58761 | 31.7 | 0.732 | |
| | | 0.2 | 1.74919 | 17.7 | 0.819 | |
| | | 0.5 | 2.03420 | 12.9 | 0.841 | |
| Poly (methyl | ITO | 0.01 | 1.49530 | 46.8 | 0.481 | |
| methacrylate) | (In₂O₃ + SnO₂) | 0.05 | 1.51632 | 27.2 | 0.368 | 2(L3) |
| | | 0.2 | 1.59266 | 12.2 | 0.281 | 1(L3), 4(L5), 5(L5) |
| | | 0.5 | 1.73531 | 7.3 | 0.249 | 3(L5) |
| Polycarbonate | TiO₂ | 0.05 | 1.66231 | 20.4 | 0.714 | |
| | | 0.2 | 1.87806 | 13.1 | 0.751 | 1(L1), 3(L8) |
| | | 0.5 | 2.24830 | 10.4 | 0.758 | |
| | ZnO | 0.05 | 1.60235 | 25.9 | 0.648 | |
| | | 0.2 | 1.65656 | 18.3 | 0.642 | |
| | | 0.5 | 1.75998 | 12.9 | 0.635 | 1(L8) |

The zoom lens system according to the present invention is applicable to a digital input device, such as a digital camera, a mobile telephone, a surveillance camera in a surveillance system, a Web camera or a vehicle-mounted camera. In particular, the zoom lens system according to the present invention is suitable for a photographing optical system where high image quality is required like in a digital camera.

Although the present invention has been fully described by way of example with reference to the accompanying drawings, it is to be understood that various changes and modifications will be apparent to those skilled in the art. Therefore, unless otherwise such changes and modification depart from the scope of the present invention, they should be construed as being included therein.

What is claimed is:

1. A zoom lens system having a plurality of lens units, each lens unit being composed of at least one lens element, the zoom lens system, in order from an object side to an image side, comprising:
a first lens unit having positive optical power; and
at least one subsequent lens unit, wherein
in zooming from a wide-angle limit to a telephoto limit at the time of image taking, an interval between the first lens unit and a lens unit which is one of the at least one subsequent lens unit varies, and
at least one lens element among all the lens elements constituting the lens system satisfies the following condition (1) or (2):
$$\begin{matrix}I ) when vd < 23 \\ 0.0002399 \times {vd}^{2} - 0.0123 \times vd + 0.8157 - θ gF < 0 \\ II ) when 23 \leq vd < 80 \\ θ gF > 0.66\end{matrix} \} \qquad ( 1 )$$
−0.00325×vd+0.69−θgF>0 (2)
(here, ω_{W}>77)
where,
vd is an Abbe number to the d-line of the lens element constituting the lens system,
θgF is a partial dispersion ratio of the lens element constituting the lens system, which is the ratio of a difference between a refractive index to the g-line and a refractive index to the F-line, to a difference between a refractive index to the F-line and a refractive index to the C-line, and
ω_{W} is a view angle (°) at a wide-angle limit.

2. The zoom lens system as claimed in claim 1, wherein the following condition (3) is satisfied:
0.20<(L_{T}×f_{W})/(H_{T}×f_{T})<1.31 (3)
where,
L_{T} is an overall length of lens system at a telephoto limit (an optical axial distance from an object side surface of a lens element positioned closest to the object side in the lens system, to an image surface),
f_{W} is a focal length of the entire system at a wide-angle limit,
f_{T} is a focal length of the entire system at a telephoto limit, and
H_{T} is an image height at a telephoto limit.

3. The zoom lens system as claimed in claim 1, wherein the following condition (4) is satisfied:
0.10<(f₁×f_{W})/(H_{T}×f_{T})<0.73 (4)
where,
f₁ is a focal length of the first lens unit,
f_{W} is a focal length of the entire system at a wide-angle limit,
f_{T} is a focal length of the entire system at a telephoto limit, and
H_{T} is an image height at a telephoto limit.

4. The zoom lens system as claimed in claim 1, wherein
a second lens unit is located closest to the object side in the subsequent lens units, and
the following condition (5) is satisfied:
−80.00<f_{T}/f₂<−12.31 (5)
where,
f_{T} is a focal length of the entire system at a telephoto limit, and
f₂ is a focal length of the second lens unit.

5. The zoom lens system as claimed in claim 1, wherein
a second lens unit is located closest to the object side in the subsequent lens units, and
the following condition (6) is satisfied:
11.76<f_{T}/M₂<70.00 (6)
where,
f_{T} is a focal length of the entire system at a telephoto limit, and
M₂ is an optical axial thickness of the second lens unit (an optical axial distance from an object side surface of a most object side lens element to an image side surface of a most image side lens element).

6. The zoom lens system as claimed in claim 1, wherein
at least one lens element among lens elements constituting the first lens unit satisfies the condition (1) or (2).

7. An imaging device capable of outputting an optical image of an object as an electric image signal, comprising:
a zoom lens system that forms an optical image of the object; and
an image sensor that converts the optical image formed by the zoom lens system into the electric image signal, wherein
the zoom lens system is a zoom lens system as claimed in claim 1.

8. A camera for converting an optical image of an object into an electric image signal and then performing at least one of displaying and storing of the converted image signal, comprising:
an imaging device including a zoom lens system that forms an optical image of the object and an image sensor that converts the optical image formed by the zoom lens system into the electric image signal, wherein
the zoom lens system is a zoom lens system as claimed in claim 1.

9. A zoom lens system having a plurality of lens units, each lens unit being composed of at least one lens element, the zoom lens system, in order from an object side to an image side, comprising:
a first lens unit having positive optical power; and
at least one subsequent lens unit, wherein
in zooming from a wide-angle limit to a telephoto limit at the time of image taking, an interval between the first lens unit and a lens unit which is one of the at least one subsequent lens unit varies, and
at least one lens element among all the lens elements constituting the lens system satisfies the following condition (2):
−0.00325×vd+0.69−θgF>0 (2)
(here, f_{T}/f_{W}>12)
where,
vd is an Abbe number to the d-line of the lens element constituting the lens system,
θgF is a partial dispersion ratio of the lens element constituting the lens system, which is the ratio of a difference between a refractive index to the g-line and a refractive index to the F-line, to a difference between a refractive index to the F-line and a refractive index to the C-line,
f_{W} is a focal length of the entire system at a wide-angle limit, and
f_{T} is a focal length of the entire system at a telephoto limit.

10. The zoom lens system as claimed in claim 9, wherein
the first lens unit includes a lens element satisfying the condition (2), and the lens element satisfying the condition (2) satisfies the following condition (7):
1/R₁−1/R₂<0 (7)
where,
R₁ is a radius of curvature of an object side surface of the lens element satisfying the condition (2), and
R₂ is a radius of curvature of an image side surface of the lens element satisfying the condition (2).

11. The zoom lens system as claimed in claim 9, wherein the following condition (3) is satisfied:
0.20<(L_{T}×f_{W})/(H_{T}×f_{T})<1.31 (3)
where,
L_{T} is an overall length of lens system at a telephoto limit (an optical axial distance from an object side surface of a lens element positioned closest to the object side in the lens system, to an image surface),
f_{W} is a focal length of the entire system at a wide-angle limit,
f_{T} is a focal length of the entire system at a telephoto limit, and
H_{T} is an image height at a telephoto limit.

12. The zoom lens system as claimed in claim 9, wherein the following condition (4) is satisfied:
0.10<(f₁×f_{W})/(H_{T}×f_{T})<0.73 (4)
where,
f₁ is a focal length of the first lens unit,
f_{W} is a focal length of the entire system at a wide-angle limit,
f_{T} is a focal length of the entire system at a telephoto limit, and
H_{T} is an image height at a telephoto limit.

13. The zoom lens system as claimed in claim 9, wherein
a second lens unit is located closest to the object side in the subsequent lens units, and
the following condition (5) is satisfied:
−80.00<f_{T}/f₂<−12.31 (5)
where,
f_{T} is a focal length of the entire system at a telephoto limit, and
f₂ is a focal length of the second lens unit.

14. The zoom lens system as claimed in claim 9, wherein
a second lens unit is located closest to the object side in the subsequent lens units, and
the following condition (6) is satisfied:
11.76<f_{T}/M₂<70.00 (6)
where,
f_{T} is a focal length of the entire system at a telephoto limit, and
M₂ is an optical axial thickness of the second lens unit (an optical axial distance from an object side surface of a most object side lens element to an image side surface of a most image side lens element).

15. The zoom lens system as claimed in claim 9, wherein
at least one lens element among lens elements constituting the first lens unit satisfies the following condition (1) or (2):
$$\begin{matrix}I ) when vd < 23 \\ 0.0002399 \times {vd}^{2} - 0.0123 \times vd + 0.8157 - θ gF < 0 \\ II ) when 23 \leq vd < 80 \\ θ gF > 0.66\end{matrix} \} \qquad ( 1 )$$
−0.00325×vd+0.69−θgF>0 (2)
where,
vd is an Abbe number to the d-line of the lens element constituting the first lens unit, and
θgF is a partial dispersion ratio of the lens element constituting the first lens unit, which is the ratio of a difference between a refractive index to the g-line and a refractive index to the F-line, to a difference between a refractive index to the F-line and a refractive index to the C-line.

16. An imaging device capable of outputting an optical image of an object as an electric image signal, comprising:
a zoom lens system that forms an optical image of the object; and
an image sensor that converts the optical image formed by the zoom lens system into the electric image signal, wherein
the zoom lens system is a zoom lens system as claimed in claim 9.

17. A camera for converting an optical image of an object into an electric image signal and then performing at least one of displaying and storing of the converted image signal, comprising:
an imaging device including a zoom lens system that forms an optical image of the object and an image sensor that converts the optical image formed by the zoom lens system into the electric image signal, wherein
the zoom lens system is a zoom lens system as claimed in claim 9.
